(19) United States
(12) Patent Application Publication
(10) Pub. No.: US 2023/0236608 A1
(43) Pub. Date: Jul. 27, 2023

(54) METHOD AND SYSTEM FOR INSPECTING A BUILDING CONSTRUCTION SITE USING A MOBILE ROBOTIC SYSTEM

(71) Applicant: NANYANG TECHNOLOGICAL UNIVERSITY, Singapore (SG)

(72) Inventors: Chien Chern CHEAH, Singapore (SG); Muhammad ILYAS, Singapore (SG); Nithish MUTHUCHAMY SELVARAJ, Singapore (SG); Yuxin JIN, Singapore (SG); Xinge ZHAO, Singapore (SG); I-Ming CHEN, Singapore (SG)

(21) Appl. No.: 18/158,309

(22) Filed: Jan. 23, 2023

(30) Foreign Application Priority Data
Jan. 24, 2022 (SG) 10202200709W

(51) Int. Cl. G05D 1/02; G06V 20/10; G06V 20/56; G06V 10/82; G06T 7/60

(52) U.S. Cl. CPC G05D 1/0274; G05D 1/0246; G06V 20/176; G06V 20/56; G06V 10/82; G06T 7/60; G05D 2201/0207; G06T 2207/10028; G06T 2207/20024; G06T 2207/20081; G06T 2207/20084; G06T 2207/30184

(57) ABSTRACT

A method of inspecting a building construction site using a mobile robotic system includes a mobile platform and a sensor system mounted on the mobile platform and configured to generate one or more types of sensor data. The method includes: receiving object identification information identifying at least one building object to be inspected by the mobile robotic system in the building construction site; obtaining a robot navigation map covering the at least one building object based on a building information model for the building construction site; and determining at least one goal point in the robot navigation map for the at least one building object, each goal point being a position in the robot navigation map for the mobile robotic system to navigate autonomously to for inspecting corresponding one or more building objects of the at least one building object. A corresponding inspection system is also provided.

### CROSS-REFERENCE TO RELATED APPLICATION

This application claims the benefit of priority of Singapore Patent Application No. 10202200709 W, filed on 24 Jan. 2022, the content of which being hereby incorporated by reference in its entirety for all purposes.

### TECHNICAL FIELD

The present invention generally relates to a method of inspecting a building construction site using a mobile robotic system, and a system thereof.

### BACKGROUND

The construction industry plays a pivotal role in the economic growth of many countries, but still, most of the construction works are heavily labor-intensive, dangerous, and inefficient. Therefore, the adoption of robotics and automation has a great potential to revolutionize the industry by providing tremendous improvements in productivity and quality in many ways. From a safety point of view, deploying robotic systems on construction sites greatly reduces possible hazards onsite in conducting dangerous tasks such as maneuvering heavy and dangerous construction materials and working at high-rise buildings. On top of that, the recent severe outbreak of the COVID-19 pandemic across the world has upset the construction industry in terms of progress delay, productivity loss, and health hazards as the industry relies heavily on manual processes, which are prone to instrumental and human errors and fatigue. Therefore, an immense requirement of construction automation has been realized in recent times. In Automation in Construction, different kinds of robotics or mechatronics systems may be deployed to perform specific tasks. For example, a painting robot may be used to work safely with human coworkers to complete painting tasks. A robot-based steel beam assembly system may be an alternative to ironworkers. Furthermore, in a semi or fully automated construction environment, various systems can interact with each other. The assembly, finishing, and painting tasks may be dependent on the outcome of the progress inspection system, which generates the progress report and instructs other robotic systems to complete the task.

Construction robots may be classified into various categories, including construction progress monitoring mobile robots. Inspection is a crucial stage in the progress monitoring of the construction process to ensure work completion in a stipulated time frame adhering to the construction standards. The inspection work may be broadly classified into two categories, namely, in-progress inspection and quality inspection. In conventional in-progress inspection, a supervisor checks the progress with naked eye and manual instruments to determine whether installation work is completed and generates a report showing the percentage of work completed at a particular time. The quality inspection is the final inspection stage carried out before handing over to the customer. This involves rigorous checks of fine details and rectification of defects in the post-construction stage if required. In an attempt to automate the inspection process, mobile robot systems with various onboard sensors may be used. For example, a post-construction quality inspection robot using scan sensors may be used to pick up building defects, such as hollowness, crack, evenness, alignments, and inclination. A mobile robot with a 2D/3D object detection system based on an RGB-D camera may be used to update the building information model (BIM) directly. As another example, a manually driven mobile robot system with a charge-coupled device camera may be used for inspecting the cracks in concrete structures using image processing techniques.

Conventionally, most of the construction work progress monitoring is performed manually. In under-construction buildings, regular inspections are carried out to ensure project completion as per approved plans and quality standards. In this regard, expert human inspectors may be deployed onsite to perform inspection tasks with the naked eye and conventional tools. However, such conventional methods or approaches are time-consuming, labor-intensive, dangerous, repetitive, and may yield subjective results.

A need therefore exists to provide a method of inspecting a building construction site and a system thereof, that seek to overcome, or at least ameliorate, one or more deficiencies in conventional approaches in construction progress monitoring, and more particularly, to automate construction progress monitoring with enhanced or improved robustness and reliability. It is against this background that the present invention has been developed.

### SUMMARY

According to a first aspect of the present invention, there is provided a method of inspecting a building construction site using a mobile robotic system, the mobile robotic system comprising a mobile platform and a sensor system mounted on the mobile platform and configured to generate one or more types of sensor data, the method comprising:

receiving object identification information identifying at least one building object to be inspected by the mobile robotic system in the building construction site;

obtaining a robot navigation map covering the at least one building object based on a building information model for the building construction site; and

determining at least one goal point in the robot navigation map for the at least one building object, each goal point being a position in the robot navigation map for the mobile robotic system to navigate autonomously to for inspecting corresponding one or more building objects of the at least one building object, wherein

said each goal point is determined based on geometric information associated with the corresponding one or more building objects extracted from the building information model and geometric information associated with an imaging sensor of the sensor system for optimizing coverage of the corresponding one or more building objects by the imaging sensor.

According to a second aspect of the present invention, there is provided a system for inspecting a building construction site using a mobile robotic system, the mobile robotic system comprising a mobile platform and a sensor system mounted on the mobile platform and configured to generate one or more types of sensor data, the system comprising:

at least one memory; and

at least one processor communicatively coupled to the at least one memory and configured to perform the method of inspecting the building construction site according to the above-mentioned first aspect of the present invention.

According to a third aspect of the present invention, there is provided a computer program product, embodied in one or more non-transitory computer-readable storage mediums, comprising instructions executable by at least one processor to perform the method of inspecting the building construction site according to the above-mentioned first aspect of the present invention.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a schematic flow diagram of a method of inspecting a building construction site using a mobile robotic system, according to various embodiments of the present invention;

FIG. 2 depicts a schematic block diagram of a system for inspecting a building construction site using a mobile robotic system, according to various embodiments of the present invention;

FIG. 3 depicts a schematic drawing of a mobile robotic system used by the method, or included in the system, for inspecting a building construction site, according to various embodiments of the present invention;

FIGS. 4A to 4D illustrate four example different datasets for the system, corresponding to four different detection models, according to various example embodiments of the present invention;

FIG. 5 depicts a schematic drawing illustrating various components of the system for inspecting a building construction site, according to various example embodiments of the present invention;

FIG. 6 depicts a schematic drawing illustrating an example mechatronics architecture of the mobile robotic system customized for a building inspection, according to various example embodiments of the present invention;

FIGS. 7A to 7C depict a schematic flow diagram illustrating a method of generating ROS map (occupancy grid map) and 3D simulation world based on the BIM, according to various example embodiments of the present invention;

FIGS. 8A to 8F illustrate a method of determining or designing a goal point (GP) for object detection based on BIM information, according to various example embodiments;

FIG. 9 shows an example method (e.g., algorithm) for BIM-based navigation to cover objects in view to perform detection tasks, according to various example embodiments of the present invention;

FIG. 10 depicts a schematic drawing illustrating an example data and information-based CNN detector, according to various example embodiments of the present invention;

FIG. 11A illustrates a camera frame and a BIM frame, according to various example embodiments of the present invention;

FIG. 11B illustrates an object detection in the image plane, according to various example embodiments of the present invention;

FIGS. 12A to 12C show detection results of building components at the actual construction site, according to various example embodiments of the present invention;

FIG. 13A illustrates detection results for an unfilled gap between staircase module and corridor, according to various example embodiments of the present invention;

FIG. 13B illustrates detection results for a filled gap between two PPVC blocks, according to various example embodiments of the present invention;

FIG. 13C illustrates detection results for a misalignment between tiles, according to various example embodiments of the present invention;

FIG. 13D illustrates detection results for tile damages, according to various example embodiments of the present invention;

FIG. 13E illustrates detection results for wall crack detection by the system in a real PPVC dataset, according to various example embodiments of the present invention;

FIGS. 14A and 14B show detection and localization results of building materials onsite and wall defects, according to various example embodiments of the present invention;

FIG. 15 shows a table (Table 1) presenting localization results of the building materials and wall defects detected, according to various example embodiments of the present invention;

FIGS. 16A and 16B illustrate a false detection filtering, according to various example embodiments of the present invention;

FIG. 17 depicts a table (Table II) showing that the falsely detected object (i.e., Switch 6) has zero IoU, while other objects have IoU larger than 0.5, according to various example embodiments of the present invention;

FIGS. 18A and 18B illustrate a fine maneuver performed, according to various example embodiments of the present invention;

FIGS. 19A and 19B illustrate PPE (personal protective equipment) safety monitoring, according to various example embodiments of the present invention;

FIG. 20 shows a table (Table III) comparing a detector according to various example embodiments of the present invention with a conventional YOLOv3 for building component detection; and

FIG. 21 depicts a flow diagram illustrating the inspection checklist update process, according to various example embodiments.

### DETAILED DESCRIPTION

Various embodiments of the present invention provide a method of inspecting a building construction site using a mobile robotic system, and a system thereof.

As explained in the background, conventionally, most of the construction work progress monitoring is performed manually. In under-construction buildings, regular inspections are carried out to ensure project completion as per approved plans and quality standards. In this regard, expert human inspectors may be deployed onsite to perform inspection tasks with the naked eye and conventional tools. However, such conventional methods or approaches are time-consuming, labor-intensive, dangerous, repetitive, and may yield subjective results. Accordingly, various embodiments of the present invention provide a method of inspecting a building construction site and a system thereof, that seek to overcome, or at least ameliorate, one or more deficiencies in conventional approaches in construction progress monitoring, and more particularly, to automate construction progress monitoring with enhanced or improved robustness and reliability.

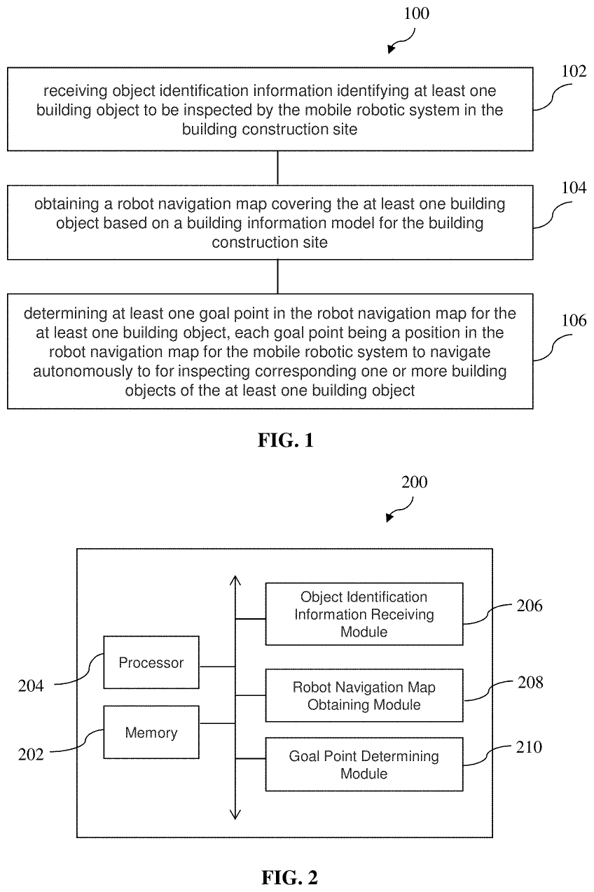

FIG. 1 depicts a schematic flow diagram of a method 100 of inspecting a building construction site using a mobile robotic system, according to various embodiments of the present invention. The mobile robotic system comprises a mobile platform and a sensor system mounted on the mobile platform and configured to generate one or more types of sensor data. The method 100 comprises: receiving (at 102) object identification information identifying at least one building object to be inspected by the mobile robotic system in the building construction site; obtaining (at 104) a robot navigation map covering the at least one building object based on a building information model for the building construction site; and determining (at 106) at least one goal point in the robot navigation map for the at least one building object, each goal point being a position in the robot navigation map for the mobile robotic system to navigate autonomously to for inspecting corresponding one or more building objects of the at least one building object. In particular, the above-mentioned each goal point is determined based on geometric information associated with the corresponding one or more building objects extracted from the building information model and geometric information associated with an imaging sensor of the sensor system for optimizing coverage of the corresponding one or more building objects by the imaging sensor.

In various embodiments, the object identification information may identify one or more building objects (e.g., corresponding to a checklist of building objects) in the building construction site to be inspected by the mobile robotic system as desired or selected by a user (e.g., a supervisor of the building construction site). In various embodiments, each building object may be any building component of a building construction site, such as but not limited to, a wall, a door, a window, a stair, an electrical outlet, a furniture, a space and so on. It will be appreciated by a person skilled in the art that many different types of building objects or components are possible and within the scope of the present invention, and it is not necessary to list each and every possible building component herein for clarity and conciseness.

In various embodiments, a building information model (BIM) may be designed or configured for a building construction site for constructing a building thereat and each building object may be a building object of, or included in, the BIM for the building construction site. It will be appreciated by a person skilled in the art the BIM designed for the building construction site includes geometric and semantic information or data of building components thereof.

In various embodiments, the above-mentioned determining (at 106) at least one goal point for the at least one building object may determine a plurality of goal points for a plurality of corresponding building objects, respectively (for the mobile robotic system to navigate autonomously to, in sequence (i.e., one after another)), or may determine one goal point for a corresponding plurality of building objects collectively. In various embodiments, one goal point may be determined for a corresponding plurality of building objects collectively if the corresponding plurality of building objects satisfy at least a proximity condition.

Accordingly, the method 100 of inspecting a building construction site according to various embodiments of the present invention advantageously automates construction progress monitoring with enhanced or improved robustness and reliability. In particular, not only is the mobile robotic system configured to navigate autonomously to inspect the building construction site, one or more goal points are determined for the mobile robotic system to navigate autonomously to inspecting corresponding one or more building objects, whereby each goal point is determined based on geometric information associated with the corresponding one or more building objects extracted from the BIM and geometric information associated with an imaging sensor of the sensor system. By determining the goal point based on such geometric information, the coverage of the corresponding one or more building objects by the imaging sensor can be advantageously optimized, resulting in automated construction progress monitoring with enhanced or improved robustness and reliability. Furthermore, since the robot navigation map for the mobile robotic system to navigate autonomously is obtained based on the BIM for the building construction site, the need for pre-exploration or mapping of the environment to generate a robot navigation map is advantageously eliminated, thereby enhancing efficiency. These advantages or technical effects, and/or other advantages or technical effects, will become more apparent to a person skilled in the art as the method 100 of inspecting a building construction site, as well as the corresponding system for inspecting a building construction site, is described in more detail according to various embodiments and example embodiments of the present invention.

In various embodiments, the geometric information associated with the corresponding one or more building objects comprises, for each of the corresponding one or more building objects, a location, a dimension and a surface normal vector of the building object. In various embodiments, the geometric information associated with the imaging sensor comprises a height and a field of view of the imaging sensor.

In various embodiments, the at least one building object comprises a plurality of building objects. In this regard, the above-mentioned determining (at 106) the at least one goal point for the at least one building object comprises: determining whether the plurality of building objects satisfy a proximity condition and a surface angle condition; and determining one goal point for the plurality of building objects collectively if the plurality of building objects are determined to satisfy the proximity condition and the surface angle condition. For example, one goal point may be determined for a plurality of building objects collectively if the plurality of building objects are determined to be sufficiently close to each other and coplanar.

In various embodiments, for the above-mentioned each goal point determined: the mobile robotic system is configured to navigate to the goal point for obtaining an image of the corresponding one or more building objects. In this regard, the method 100 further comprises determining a state of each of the corresponding one or more building objects using a convolutional neural network (CNN)-based object detector based on the image of the corresponding one or more building objects obtained and the building information model. In this regard, the CNN-based object detector comprises one or more detection models (different types of detection models). In various embodiments, each detection model is trained to detect a corresponding type of state of building objects.

In various embodiments, the type of state of building objects is one of a building component installation completion type, a building component defect type and a building material presence type. In various embodiments, the building component installation completion type may refer to a state indicating whether the building object has completed installation. The building component defect type may refer to a state indicating whether the building object has a defect (e.g., the location of the defect may be indicated). The building material presence type may refer to a state indicating whether a building material is present.

In various embodiments, the above-mentioned determining the state of each of the corresponding one or more building objects comprises, for each corresponding building object: detecting the corresponding building object in the image based on the CNN-based object detector to obtain a detection result; localizing the detected corresponding building object in the image in a coordinate frame of the building information model; determining geometric information of the detected corresponding building object; determining whether the geometric information of the detected corresponding building object determined and corresponding geometric information associated with the detected corresponding building object extracted from the building information model satisfy a matching condition; and filtering the detection result of the corresponding building object based on whether the geometric information of the detected corresponding building object determined and the corresponding geometric information associated with the detected corresponding building object extracted from the building information model satisfy the matching condition.

Accordingly, the robustness and reliability of the method 100 in automated construction progress monitoring is advantageously further enhanced or improved according to various embodiments of the present invention. In particular, by utilizing the geometric information of the detected corresponding building object determined and the corresponding geometric information associated with the detected corresponding building object extracted from the building information model, the method 100 is advantageously able to filter out false detections based on whether they satisfy a matching condition (e.g., whether they are the same or within an acceptable difference), thereby improving the reliability of the detection results.

In various embodiments, the geometric information of the detected corresponding building object determined comprises at least one of a location, a dimension and an orientation of detected corresponding building object. In various embodiments, the geometric information associated with the detected corresponding building object extracted from the building information model comprises at least one of a location, a dimension and an orientation of detected corresponding building object.

In various embodiments, the above-mentioned localizing the detected corresponding building object in the image in the coordinate frame of the building information model comprises: converting two-dimensional (2D) image points of the image in a coordinate frame of the image to three-dimensional (3D) image points in a coordinate frame of the imaging sensor; and transforming the 3D image points in the coordinate frame of the imaging sensor into 3D image points in the coordinate frame of the building information model.

In various embodiments, the 2D image points of the image in the coordinate frame of the image are converted to the 3D image points in the coordinate frame of the imaging sensor based on a distance between the detected corresponding building object and the imaging sensor obtained from a distance sensor of the sensor system. In various embodiments, the 3D image points in the coordinate frame of the imaging sensor are transformed into 3D image points in the coordinate frame of the building information model based on a series of homogeneous transformation matrices.

In various embodiments, the method 100 further comprises, for each of one or more of the above-mentioned at least one goal point determined: rotating the imaging sensor based on a reference point in the image of the corresponding one or more building objects obtained and a reference point for one or more bounding boxes of the corresponding one or more building objects detected in the image.

In various embodiments, the imaging sensor is rotated by an amount based on a distance between the reference point in the image and the reference point for the one or more bounding boxes.

In various embodiments, the reference point in the image is a center point thereof, and the reference point of the one or more bounding boxes is determined based on a center point of each of the one or more bounding boxes.

In various embodiments, the method 100 further comprises: refining the goal point determined by adjusting a distance between the mobile robotic system and the building object based on a dimension of the object and a dimension of an anchor box for detecting the corresponding one or more building objects in the image.

Accordingly, the robustness and reliability of the method 100 in automated construction progress monitoring is advantageously further enhanced or improved according to various embodiments of the present invention. For example, the goal point may be refined or revised to enable the building object to be better captured by the imaging sensor. For example, when the building object detected is relatively small, the goal point may be refined or revised so as to move the mobile robotic system closer to the building object to enable the building object to be better captured by the imaging sensor.

In various embodiments, the distance is adjusted based on a difference between the dimension of the object and the dimension of the anchor box.

In various embodiments, the dimension of the object is a height thereof, and the dimension of the anchor box for detecting the object is a height thereof.

In various embodiments, the method 100 further comprises generating an inspection report comprising the determined state of each of the at least one building object.

In various embodiments, the building construction site is a prefabricated prefinished volumetric construction (PPVC) site.

In various embodiments, the mobile robotic system comprises at least one memory and at least one processor communicatively coupled to the at least one memory. The at least one processor 304 is configured to control the mobile platform to navigate autonomously in the building construction site based on a robot operating system (ROS).

FIG. 2 depicts a schematic block diagram of a system 200 for inspecting a building construction site using a mobile robotic system according to various embodiments of the present invention, corresponding to the above-mentioned method 100 of inspecting a building construction site as described hereinbefore according with reference to FIG. 1 according to various embodiments of the present invention. The mobile robotic system comprises a mobile platform and a sensor system mounted on the mobile platform and configured to generate one or more types of sensor data. The system 200 comprises: at least one memory 202; and at least one processor 204 communicatively coupled to the at least one memory 202 and configured to perform the method 100 of inspecting the building construction site according to various embodiments of the present invention. Accordingly, the at least one processor 204 is configured to: receive object identification information identifying at least one building object to be inspected by the mobile robotic system in the building construction site; obtain a robot navigation map covering the at least one building object based on a building information model for the building construction site; and determine at least one goal point in the robot navigation map for the at least one building object, each goal point being a position in the robot navigation map for the mobile robotic system to navigate autonomously to for inspecting corresponding one or more building objects of the at least one building object. In particular, the above-mentioned each goal point is determined based on geometric information associated with the corresponding one or more building objects extracted from the building information model and geometric information associated with an imaging sensor of the sensor system for optimizing coverage of the corresponding one or more building objects by the imaging sensor.

It will be appreciated by a person skilled in the art that the at least one processor 204 may be configured to perform various functions or operations through set(s) of instructions (e.g., software modules) executable by the at least one processor 204 to perform various functions or operations. Accordingly, as shown in FIG. 2, the system 200 may comprise: an object identification information receiving module (or an object identification information receiving circuit) 206 configured to receive object identification information identifying at least one building object to be inspected by the mobile robotic system in the building construction site; a robot navigation map obtaining module (or a robot navigation map obtaining circuit) 208 configured to obtain a robot navigation map covering the at least one building object based on a building information model for the building construction site; and a goal point determining module (or a goal point determining circuit) 210 configured to determine at least one goal point in the robot navigation map for the at least one building object, each goal point being a position in the robot navigation map for the mobile robotic system to navigate autonomously to for inspecting corresponding one or more building objects of the at least one building object.

It will be appreciated by a person skilled in the art that the above-mentioned modules are not necessarily separate modules, and two or more modules may be realized by or implemented as one functional module (e.g., a circuit or a software program) as desired or as appropriate without deviating from the scope of the present invention. For example, two or more of the object identification information receiving module 206, the robot navigation map obtaining module 208 and the goal point determining module 210 may be realized (e.g., compiled together) as one executable software program (e.g., software application or simply referred to as an “app”), which for example may be stored in the at least one memory 202 and executable by the at least one processor 204 to perform the corresponding functions or operations as described herein according to various embodiments.

In various embodiments, the system 200 for inspecting a building construction site corresponds to the method 100 of inspecting a building construction site as described hereinbefore with reference to FIG. 1, therefore, various functions or operations configured to be performed by the least one processor 204 may correspond to various steps of the method 100 described hereinbefore according to various embodiments, and thus need not be repeated with respect to the system 200 for clarity and conciseness. In other words, various embodiments described herein in context of methods (e.g., the method 100 of inspecting a building construction) are analogously valid for the corresponding systems or devices (e.g., the system 200 for inspecting a building construction), and vice versa. For example, in various embodiments, the at least one memory 202 may have stored therein the object identification information receiving module 206, the robot navigation map obtaining module 208 and/or the goal point determining module 210, each corresponding to one or more steps of the method 100 of inspecting a building construction site as described hereinbefore according to various embodiments, which are executable by the at least one processor 204 to perform the corresponding functions or operations as described herein.

A computing system, a controller, a microcontroller or any other system providing a processing capability may be provided according to various embodiments in the present invention. Such a system may be taken to include one or more processors and one or more computer-readable storage mediums. For example, the system 200 described hereinbefore may include at least one processor (or controller) 204 and at least one computer-readable storage medium (or memory) 202 which are for example used in various processing carried out therein as described herein. A memory or computer-readable storage medium used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code, e.g., Java. Any other kind of implementation of various functions or operations may also be understood as a “circuit” in accordance with various other embodiments. Similarly, a “module” may be a portion of a system according to various embodiments in the present invention and may encompass a “circuit” as above, or may be understood to be any kind of a logic-implementing entity therefrom.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “obtaining”, “determining”, “detecting”, “localizing”, “filtering”, “converting”, “transforming”, “refining”, “generating” or the like, refer to the actions and processes of a computer system or electronic device, that manipulates and transforms data represented as physical quantities within the computer system into other data similarly represented as physical quantities within the computer system or other information storage, transmission or display devices.

The present specification also discloses a system (e.g., which may also be embodied as one or more devices or apparatuses), such as the system 200, for performing various operations or functions of the method(s) described herein. Such a system may be specially constructed for the required purposes, or may comprise a general purpose computer or other device selectively activated or reconfigured by a computer program stored in the computer. Algorithms that may be presented herein are not inherently related to any particular computer or other apparatus. Various general-purpose machines may be used with computer programs in accordance with the teachings herein. Alternatively, the construction of more specialized apparatus to perform the required method steps may be appropriate.

In addition, the present specification also at least implicitly discloses a computer program or software/functional module, in that it would be apparent to the person skilled in the art that individual steps of various methods described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the present invention. It will be appreciated by a person skilled in the art that various modules described herein (e.g., the object identification information receiving module 206, the robot navigation map obtaining module 208 and/or the goal point determining module 210) may be software module(s) realized by computer program(s) or set(s) of instructions executable by a computer processor to perform various functions or operations, or may be hardware module(s) being functional hardware unit(s) designed to perform various functions or operations. It will also be appreciated that a combination of hardware and software modules may be implemented.

Furthermore, one or more of the steps of a computer program/module or method described herein may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer program when loaded and executed on such a general-purpose computer effectively results in an apparatus that implements various steps of methods described herein.

In various embodiments, there is provided a computer program product, embodied in one or more computer-readable storage mediums (non-transitory computer-readable storage medium), comprising instructions (e.g., the object identification information receiving module 206, the robot navigation map obtaining module 208 and/or the goal point determining module 210) executable by one or more computer processors to perform a method 100 of inspecting a building construction site, as described hereinbefore with reference to FIG. 1. Accordingly, various computer programs or modules described herein may be stored in a computer program product receivable by a system therein, such as the system 200 as shown in FIG. 2, for execution by at least one processor 204 of the system 200 to perform various functions or operations.

Various software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

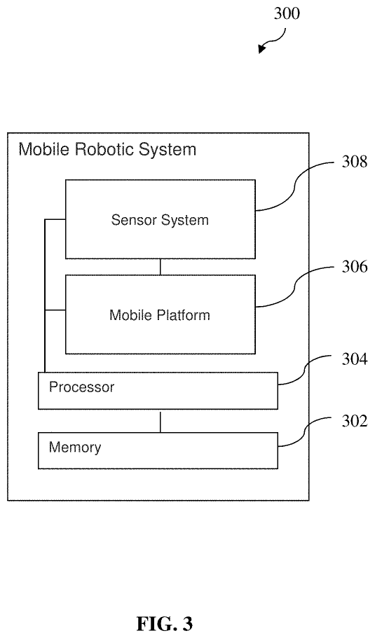

FIG. 3 depicts a schematic drawing of a mobile robotic system 300 used by the method 100 or included in the system 200 for inspecting a building construction site, according to various embodiments of the present invention. The mobile robotic system 300 comprises: a mobile platform 306 and a sensor system 308 mounted on the mobile platform 306 and configured to generate one or more types of sensor data. In various embodiments, the mobile robotic system 300 further comprises at least one memory 302; and at least one processor 304 communicatively coupled to the at least one memory 302, the mobile platform 306 and the sensor system 308. In various embodiments, the at least one processor 304 is configured to control the mobile platform to navigate autonomously in the building construction site based on a robot operating system (ROS) (e.g., stored in the at least one memory 302). In various embodiments, the object identification information receiving module 206, the robot navigation map obtaining module 208 and/or the goal point determining module 210 may be stored in the at least one memory 302. In various embodiments, the mobile robotic system 300 further comprise an inertia measurement unit (IMU) and a GPS system.

In various embodiments, the sensor system 308 may include one or more different types of sensors for sensing a surrounding environment for generating one or more different types of sensor data, respectively. For example and without limitations, the sensor system 308 may include one or more of an imaging sensor (e.g., a camera, such as an IP PTZ (plan-tilt-zoom) camera), a distance sensor (a LiDAR sensor), and an ultrasonic sensor.

It will be understood by a person skilled in the art that the present invention is not limited to any particular type of the mobile robotic system as long as the mobile robotic system may be used in the method 100 of inspecting a building construction site as described herein according to various embodiments. In various embodiments, the mobile robotic system may be ground or aerial mobile robotic system. Various configurations and operating mechanisms or principles of a mobile robotic system (e.g., robot operating system (ROS)) are known in the art and thus need not be described herein for clarity and conciseness.

It will be appreciated by a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Any reference to an element or a feature herein using a designation such as “first”, “second” and so forth does not limit the quantity or order of such elements or features, unless stated or the context requires otherwise. For example, such designations may be used herein as a convenient way of distinguishing between two or more elements or instances of an element. Thus, a reference to first and second elements does not necessarily mean that only two elements can be employed, or that the first element must precede the second element. In addition, a phrase referring to “at least one of” a list of items refers to any single item therein or any combination of two or more items therein.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

In particular, for better understanding of the present invention and without limitation or loss of generality, various example embodiments of the present invention will now be described with respect to a method of inspecting a building construction site using a mobile robotic system whereby the building construction site is a prefabricated prefinished volumetric construction (PPVC) site and the mobile robotic system is a ground mobile robotic system, for illustration purposes only. It will be understood by a person skilled in the art that the building construction site and the mobile robotic system are not limited as such. For example, the building construction site may be non-PPVC and the mobile robotic system may be aerial mobile robotic system, without going beyond the scope of the present invention.

In construction automation, robotic solution is becoming an emerging technology with the advent of artificial intelligence and advancement in mechatronic systems. In construction buildings, regular inspections are carried out to ensure project completion as per approved plans and quality standards. Conventionally, expert human inspectors are deployed onsite to perform inspection tasks with the naked eye and conventional tools. This process is time consuming, labor-intensive, dangerous, and repetitive and may yield subjective results. In contrast, various example embodiments provide a method of robot-assisted object detection for construction automation based on data and information-driven approach. In this regard, a robotic system equipped with perception sensors and intelligent algorithms may be provided to help construction supervisors remotely identify the construction materials, detect component installations and defects, and generate report of their status and location information. The building information model (BIM) is used for mobile robot navigation and to retrieve building component's location information. Unlike the conventional deep learning-based object detection, which depends heavily on training data, various example embodiments provide a data and information-driven approach, which incorporates offline training data, sensor data, and BIM information to achieve BIM-based object coverage navigation, BIM-based false detection filtering, and a fine maneuver technique to improve on object detections during real-time automated task execution by robots. This allows the user to select building components to be inspected, and the mobile robot navigates autonomously to the target components using the BIM-generated navigation map. An object detector may then detect the building components and materials and generates an inspection report.

Accordingly, various example embodiments address various problems of conventional construction progress monitoring mobile robots. In particular, various example embodiments seek to develop a mobile robotic system to aid a user (e.g., a supervisor) in in-progress inspection in an automated manner. For example, the user may load the inspection checklist of a particular floor, and the robot navigates autonomously to perform the inspection tasks. The ground mobile robot equipped with intelligent navigation and vision algorithms utilizes multiple sensors data and BIM information to plan its trajectory throughout the construction area. For example, the ground mobile robot is able to effectively perform tasks such as installation check, construction material detection, and construction defect monitoring in a PPVC site and update the inspection checklist automatically. Thereafter, an updated checklist can be retrieved for preparing a comprehensive inspection report. Accordingly, various example embodiments advantageously provide a robot-assisted object detection (RAOD) system (e.g., corresponding to the system for inspecting a building construction site as described hereinbefore according to various embodiments) using multiple forms of data (e.g., BIM and robot sensing information) to improve the detection of construction components and material recognition. In various example embodiments, the RAOD may be configured with one or more of the following features:

1) Object coverage BIM-based navigation: An object coverage BIM-based navigation is introduced for the RAOD according to various example embodiments of the present invention. Navigation goal points (GPs) are generated based on the information from the BIM and the camera, such that the objects in the inspection checklist are within the field of view (FoV) of the robot vision system. A 2D map and the 3D simulated world may also be created utilizing BIM information for navigation.

2) Data and information-driven object detection approach: In addition to a large amount of training data collected from the actual PPVC construction site used to train an object detector, the detection model is fed with prior offline information from the BIM model and information from the robot sensors to constraint around the targeted objects in the BIM checklist.

3) BIM-based false detection filtering is developed to validate the detection output with the checklist generated from the BIM. This has significantly eliminated false positive detections from the non-targeted objects in the working environment. Furthermore, to inspect small objects from a closer viewpoint, a fine maneuver technique may be used to maneuver the robot to a better GP determined by sensor data, object detection, and BIM information.

### Building Information Modeling and BIM-Based Navigation

Over the past few decades, the development of the BIM has been of great interest in the construction sector. The BIM is an integrated process that provides architecture, engineering, and construction professionals with tools and technologies to manage the whole life cycle of the building infrastructure. It adopts an object-based parametric modeling technique and generates a 3D digital representation and functional characteristics of the construction site. In the context of robot navigation and mapping, according to various example embodiments, the semantic and geometric information of building components and spaces embedded in the BIM is utilized for the generation of a navigation maps and design GPs to avoid obstacles in a construction site environment.

Traditionally, architectural drawings are used to solve the navigational problems in mobile robots. For example, there has been disclosed room-level topological map representation for large-scale path planning. There has also been disclosed a comparison of sketched floor plans with simultaneous-localization-and-mapping-generated maps, which argued that floor plans are closer to the mental maps people would naturally draw to characterize and explore spaces. There has further been disclosed an attempt to solve the navigational issues in environments using hand-drawn sketches, but only a coarse localization at room level could be achieved. Such a raw hand-drawn map approach is not suitable for construction component inspection, where accurate self-localization and navigation are required to localize the detected objects in the map in a dynamic environment.

Some researchers have started using BIM-based floor plans for route planning in 2D and 3D. There has also been disclosed a connection of the BIM to the robot operating system (ROS) to monitor construction progress, in which a 4D BIM is used to extract waypoints manually. However, an initial navigation map is still created by manually driving a mobile robotic platform. There has further been disclosed a BIM-based augmented reality application for site managers with handheld devices to visualize the key information related to progress and performance of construction works by using a location-based management system with the BIM. However, this mentioned work presents no robotic solution to the construction automation. There has also been disclosed a system for logistics assistants collaborating with human workers by sharing data between the BIM and the ROS. A costmap extracted from the BIM is used inside the ROS navigation stack. The map is then transmitted and superimposed to the one generated by the LIDAR sensors. However, this mentioned work does not fully utilize the BIM information in the generation of a 3D simulated world and in using semantic and geometric information for maximum object coverage.

### Convolutional Neural Network Applications in Construction

In recent years, the deep convolutional neural networks have garnered a lot of attention in providing a promising solution in many diverse areas, such as in medical science for lung nodule detection, diagnosis of mixed faults in rotating machinery, traffic-relevant data mining from social media, and noise detection and removal in image data. This computer-vision-based technology is, however, relatively new in the construction research study. A few discussions have been brought up to address construction-related problems with convolutional neural networks (CNNs).

For example, the CNN has been applied as a potential perspective in solving construction problems by utilizing feature extraction and classifier to identify asphalt pavement cracks. The CNN model's performance surpassed the traditional image processing technique like the Sobel and Canny edge detector algorithms. A similar study has also been carried out, in which a deep residual neural network base network is used as a backbone for extracting features of the moisture damage to perform detection in asphalt pavement bridges. However, such works are not of the scope of monitoring construction conformance. On the other hand, data-free vision-based Faster Region-proposal CNN (Faster R-CNN) has been disclosed for covering four types of construction equipment detection, which are excavator, dump truck, forklift, and loader. This mentioned work is based on active learning to select the most meaningful and informative data from onsite images to train the deep learning models sequentially using the selected ones. Classical object recognition methods and a pretrained CNN architecture have been used to identify different construction materials, e.g., brick, concrete, and wood. There has also been disclosed progress monitoring by acquiring construction images from different viewpoints to produce a 3D point cloud using structure from motion methods. While the CNN is not the fundamental focus, this mentioned work proposed the use of Mask Regions with CNN (R-CNN) to further enhance the detection of exterior elements such as columns, walls, formwork, and scaffolding. However, these mentioned works neither target the construction component installation detection nor pertain to the PPVC environment. In addition, object detection depends only on the training data and does not take advantage of BIM information of building and sensing information of robot to improve the detection tasks. In contrast, various example embodiments develop a RAOD system based on an information and data-driven robot-assisted approach for construction automation to help human supervision in PPVC construction component installation inspection, material recognition, and defect monitoring and localization. Various components of the RAOD system will now be described according to various example embodiments of the present invention.

### Robot-Assisted Object Detection

### RAOD for PPVC Construction Components

The traditional CNN models are inefficient to perform installation and quality inspection in a dynamic environment under varying lighting conditions, such as a construction site, with purely image data. Therefore, to enhance the robustness and reliability of construction inspection applications, a data and information-driven approach (including sensor data and BIM information) for object detection is provided according to various example embodiments of the present invention. On top of the images collected onsite, additional information is extracted from the BIM and robot sensors to achieve a reliable object detection. The prior and offline BIM information includes both the semantic and geometric information of the objects to be monitored. The CNN detector is trained with onsite images. However, during the testing time, this approach utilizes both the low and high-level information to perform object detection, which makes the detector more robust and reliable. The robot also uses BIM information along with real-time data from robot sensors to autonomously navigate to a designated locations to perform the inspection tasks. Accordingly, the construction automation RAOD system according to various example embodiments of the present invention is configured based on the integration of an autonomous mobile robotic platform with an intelligent object detection system that can be deployed for automated inspection of a construction site.

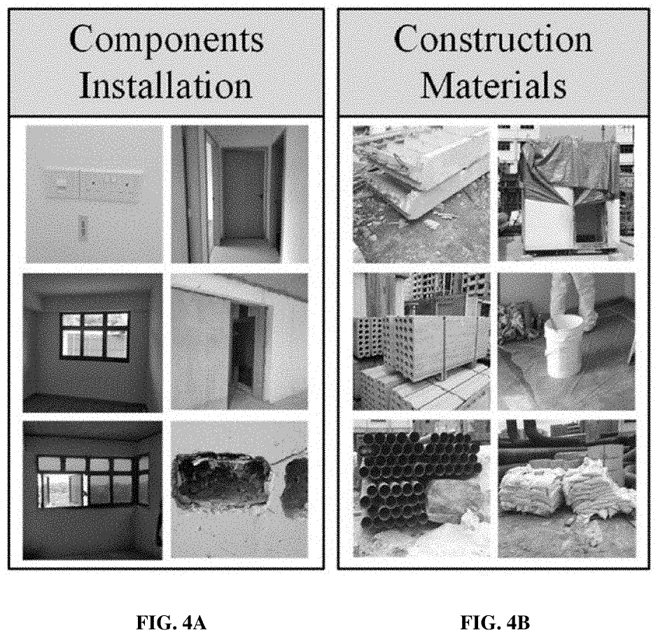

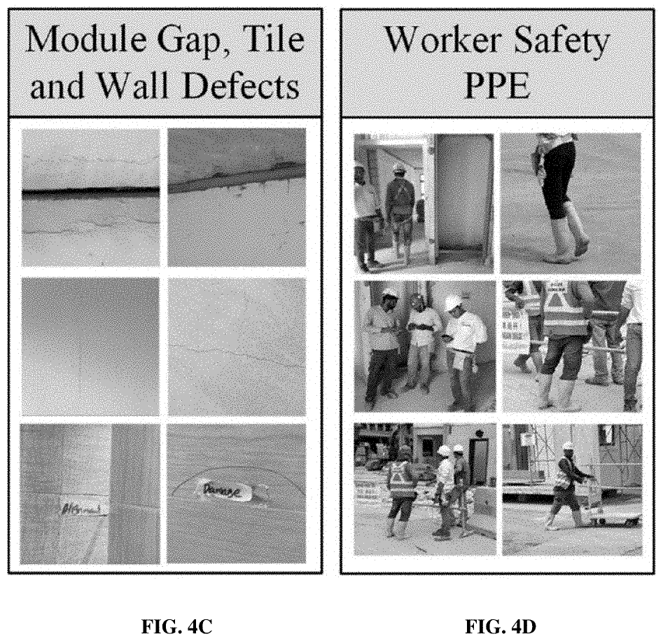

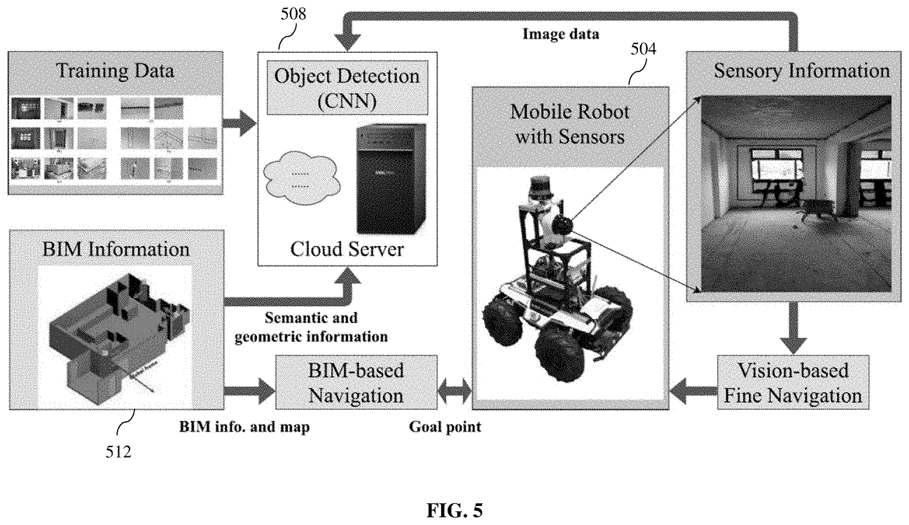

In various example embodiments, a plurality of different inspection or detection models (e.g., a total of six inspection or detection models) may be designed to be executed independently when desired or necessary, such as shown in FIGS. 4A to 4D. The object detection system is designed in a modular and scalable manner so that if needed, new inspection or detection models can be trained and easily integrated with the object detection system. By way of examples only and without limitations, FIGS. 4A to 4D illustrate four example different datasets for the RAOD system grouped into four parts or categories. FIG. 4A illustrates an example component installation dataset including finished and unfinished windows, doors, and electrical components. FIG. 4B illustrates an example material dataset such as the 3D modules, 2D wall panel, precast staircase, cement, wires, PVC pipes, and paint. FIG. 4C illustrates an example dataset such as module gap between module connections, wall defects that can commonly happen during the transportation and hoisting process, and tile defects such as damages, misalignment, and improper joint. FIG. 4D illustrates an example dataset including personal protective equipment (PPE) of workers onsite.

### Robotic System of RAOD

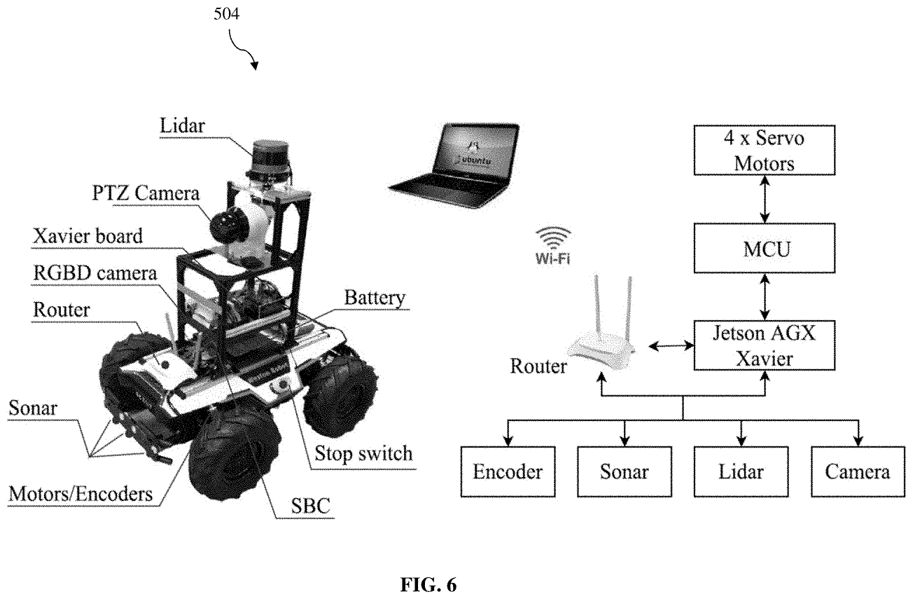

The RAOD system according to various example embodiments of the present invention comprises a mobile robotic system (or mobile robot platform, which may herein be referred to simply as a robot) configured to navigate autonomously using the information provided by the BIM to perform construction inspection based on one or more of the aforementioned detection models. For example, the robot's vision system may send a video stream to a cloud server, where the data and information-driven detection modules are used for construction component inspection, material identification, and/or defect detection. The overall RAOD system for the construction monitoring system according to various example embodiments is illustrated in FIG. 5, by way of an example only and without limitation. In particular, FIG. 5 depicts various components of the RAOD system for construction inspection, comprising a mobile robotic system 504, an object detection system 508 on a server, and a control system 512 with BIM software.

A mobile robotic system (e.g., Scout robot) 504 is customized for construction monitoring according to various example embodiments of the present invention. An example mechatronics architecture of the mobile robotic system customized for a building inspection is shown in FIG. 6, according to various example embodiments of the present invention. By way of an example only and without limitation, Scout robot may be utilized and is a four-wheel differential drive skid-steering robot with zero-degree turning radius, driven by 4×200-W brushless servo motors. This vehicle weighs about 60-65 kg with a payload capacity of 50 kg and can move at a maximum speed of 6 km/h. It is equipped with (mounted on a mobile platform or base) a variety of perception and navigation sensors, such as but not limited to, 3D lidar (RoboSense RS-LiDAR-16), a PTZ IP camera, ultrasonic sensors, GPS, IMU, and wheel encoders. The onboard processing may be implemented by Nvidia Jetson AGX Xavier, and BeagleBone Black may be used as microcontroller unit (MCU). For example, the Ubuntu 18.04 LTS operating system is running ROS onboard the Jetson computer.

In various example embodiments, a 360 degree rotating camera may be added on top of the lidar to capture images/videos of the surrounding environment. For example, the setup may include a RGB camera mounted atop 360 degree servo platform and both are controlled by a robot computer (e.g., the Jetson computer). By way of an example only and without limitation, in various example embodiments, the rotating camera may be configured to operate based on the following sequence:

1. The mobile robot reaches a goal point and commands the robot computer to control the camera to capture images.

2. Upon receiving the command, the robot computer commands the servo to rotate in incremental steps of 1 degree while simultaneously recording the video from the camera feed. As a result, a complete 360 degree video of the environment is obtained.

3. The camera also captures images at every viewpoint achieved by rotating the servo in incremental steps of 30 degrees (or any arbitrary positive integer value less than or equal to 360), thus captures 12 images of surrounding environment at each goal point.

4. Steps 1-3 are repeated until the final goal point is reached.

5. All the image and video data recorded are stored on a memory of the robot computer. The data may then be transferred to a remote server, where an object detection system 508 having a program installed runs object detection and updates the inspection checklist.

In various example embodiments, the robot computer (e.g., the Jetson computer) uses LINUX OS because of the real-time requirement of robot control. In various example embodiments, the object detection system 508 on the remote cloud server may also use LINUX OS. On the other hand, it will be appreciated by a person skilled in the art that the BIM software (e.g., Autodesk Revit) may only use WINDOWS OS. Accordingly, in various example embodiments, a separate device may be provided in the RAOD system for the BIM related steps. It will also be appreciated by a person skilled in the art that if the BIM software is available in LINUX OS, all the steps of the RAOD system may be performed in one device.

In various example embodiments, BIM related steps are offline processes where a separate Windows computer is utilized. In various example embodiments, for all the online progress monitoring steps related to robot navigation and image data acquisition, one device (i.e., the robot computer) may be utilized.

In various example embodiments, the object detection system 508 may be implemented on a remote cloud server as shown in FIG. 5 or implemented on a robot computer (i.e., object detect tasks may be performed by the robot computer). For example, smaller and efficient object detectors may be implemented on the robot computer. On the other hand, carrying out object detection tasks on a remote cloud server may provide a number of advantages. For example, a remote cloud server may be utilized by multiple users; may provide additional processing, memory and storage; avoids computational constraints associated with the robot computer (e.g., enabling the size of the robot to be reduced or minimized); and enables training and inference of AI models to be carried out in one system (in contrast to conventional paradigm of training in a GPU server, reconfiguring the detection models for various robot platforms for inference and then deploying it).

### Object Coverage BIM-Based Navigation for Object Detection

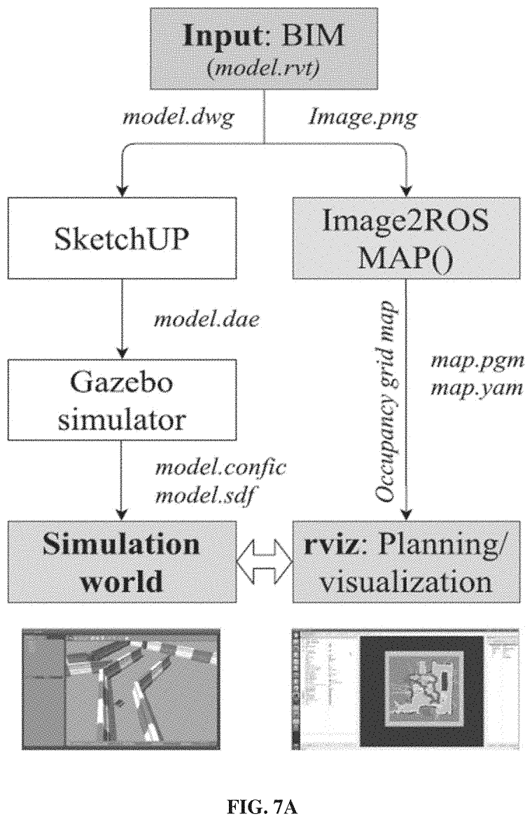

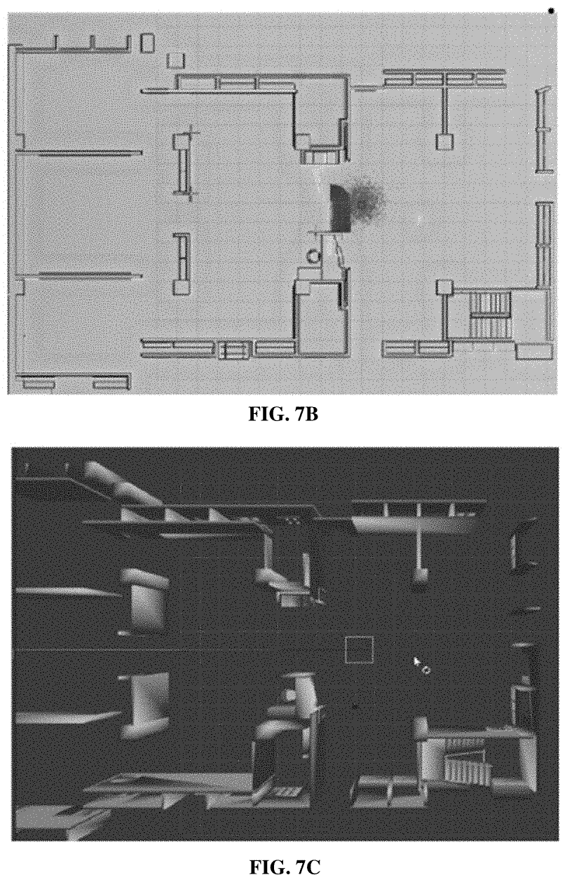

In the RAOD system according to various example embodiments, BIM-based mapping and navigation techniques are introduced. In particular, the BIM is used to create or generate robot navigation maps. For BIM-based navigation, the 2D map and 3D simulated world generation processes are illustrated in FIGS. 7A to 7C according to various example embodiments of the present invention. In particular, FIG. 7A depicts a schematic flow diagram illustrating a method of generating ROS map (occupancy grid map) and 3D simulation world based on the BIM, FIG. 7B depicts an example generated 2D ROS map, and FIG. 7C depicts an example generated 3D simulated world.

The ROS navigation map generation based on the BIM will now be described further according to various example embodiments of the present invention. The BIM designed for the building construction site is utilized or leveraged to generate 2D robot navigation maps of the environment, without the need of scanning the environment beforehand as required in conventional approaches to create navigation maps in the ROS, e.g., gmapping, hectorSlam. The 2D floor plan in the BIM has rich geometric information of building components such as but not limited to, walls, doors, windows, furniture, and so on. In various example embodiments, the robot 504 is configured to receive an inspection checklist (e.g., corresponding to the object identification information as described hereinbefore according to various embodiments) identifying at least one building object to be inspected, from a user. The robot 504 may then obtain or load the corresponding navigation map covering one or more of the building objects to be inspected and then navigate to the desired or determined goal points (GPs) in the navigation map while avoiding obstacles, thus advantageously completely eliminating the need for pre-exploration or mapping of the environment. Furthermore, to run simulations in the generated navigation map, a 3D simulated world of the working environment is required. Conventionally, the Gazebo simulator is used to draw 3D simulated world, but in various example embodiments of the present invention, the BIM is employed to generate the 3D simulated world.

A method of determining or designing a goal point (GP) for object detection will now be described further according to various example embodiments of the present invention. For example, the method advantageously enables target building object (or building component, which may simply be referred to herein as an object) to be inspected from a specific viewpoint. In contrast, conventional path planning algorithms do not consider viewing angle and viewing distance to the target building object.

Various example embodiments consider two aspects of GP design, namely, viewing distance to the object and viewing angle of the object. It is assumed that the best viewpoint of a building component is obtained from its front. For example, the coordinate of a door extracted from BIM information may be a 2D point at the middle of the bottom of the door. As this point lies beneath the door, various example embodiments design a GP for inspecting the door such that the robot 504 can observe the door (capture an image of the door) from an appropriate distance d covering the object within the camera's FoV of the robot 504.

To determine or design the GP for a building component, semantic and geometric information of the building component is extracted from BIM software according to various example embodiments of the present invention. For example, semantic information of a building component may include a component identification number (e.g., corresponding to the object identification information described hereinbefore according to various embodiments), a category of the building component, and a component label, while geometric information of a building component may include dimensions of the building component, as well as its location and surface normal vector with respect to the BIM coordinate system. Accordingly, semantic information and geometric information provided by the BIM is utilized to design the GPs in the working environment.

Let (xᵢ, yᵢ, zᵢ) be the 3D coordinates of the mid-point at the bottom of the ith target object in the BIM frame, extracted from BIM information, and Fᵢ=(Fₓᵢ, F_{yi})^{T} be the surface normal vector that is perpendicular to the ith target object surface; then, the angle to Fᵢ with respect to the x-axis of the BIM frame may be calculated as:

αᵢ=tan⁻¹(F_{yi}/Fₓᵢ) Equation (1)

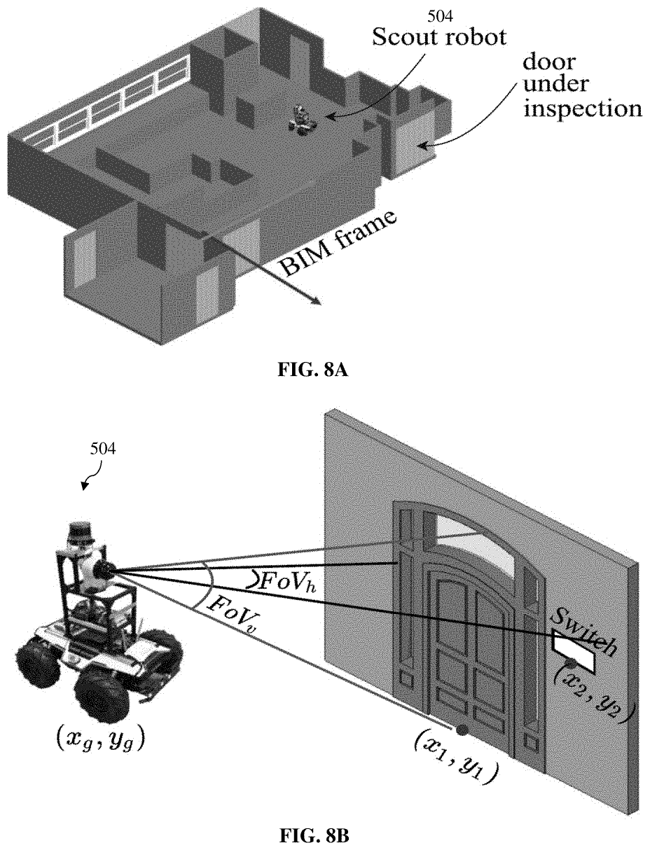

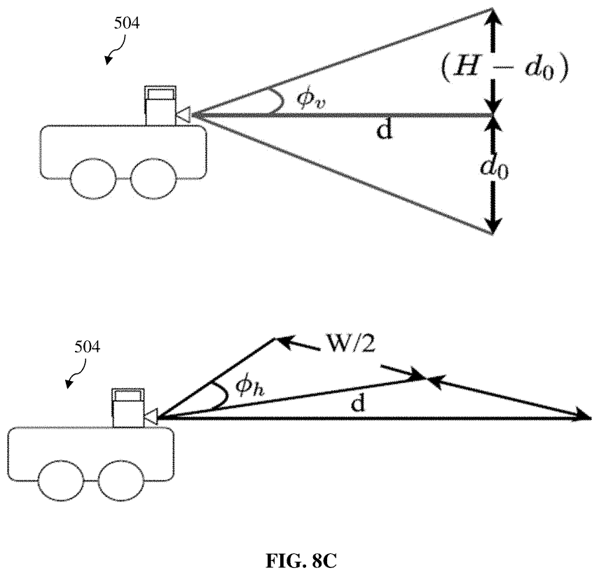

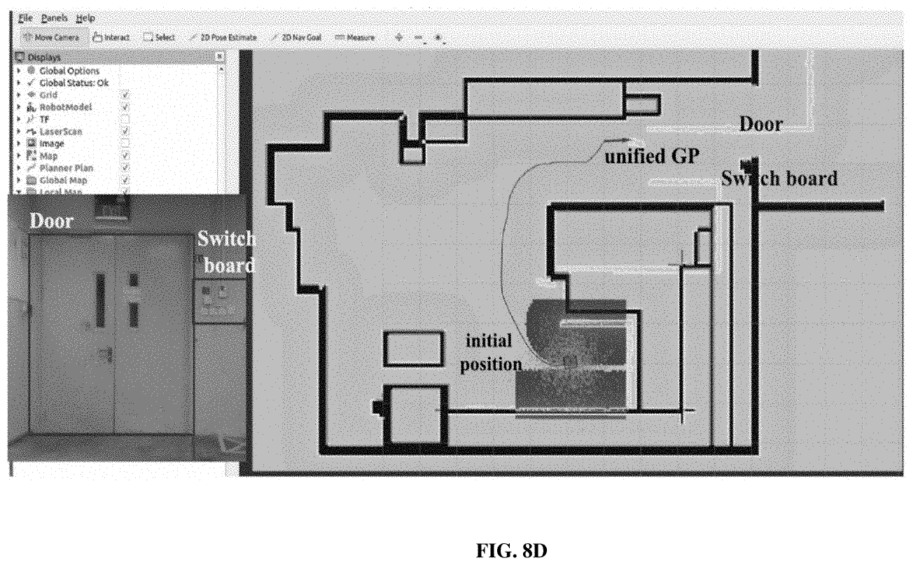

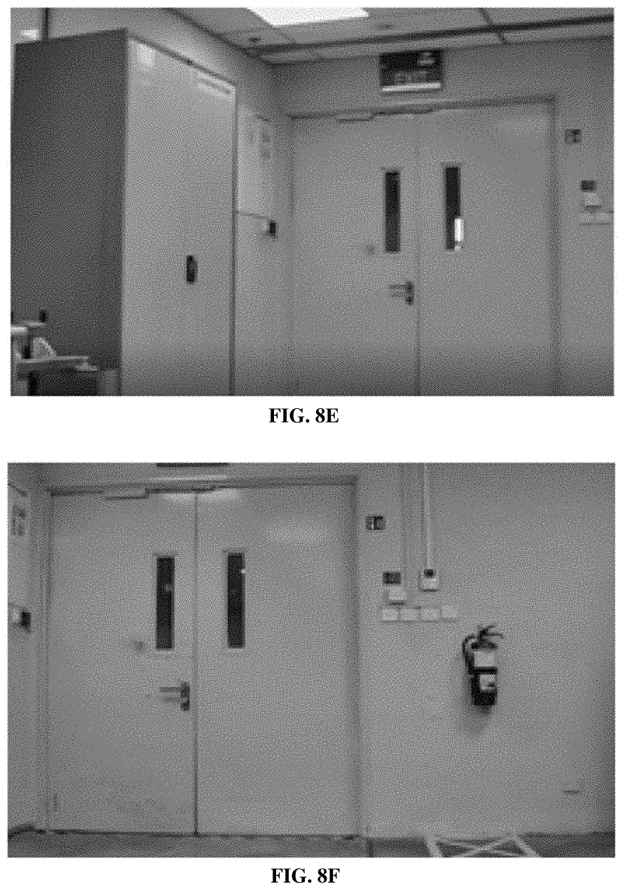

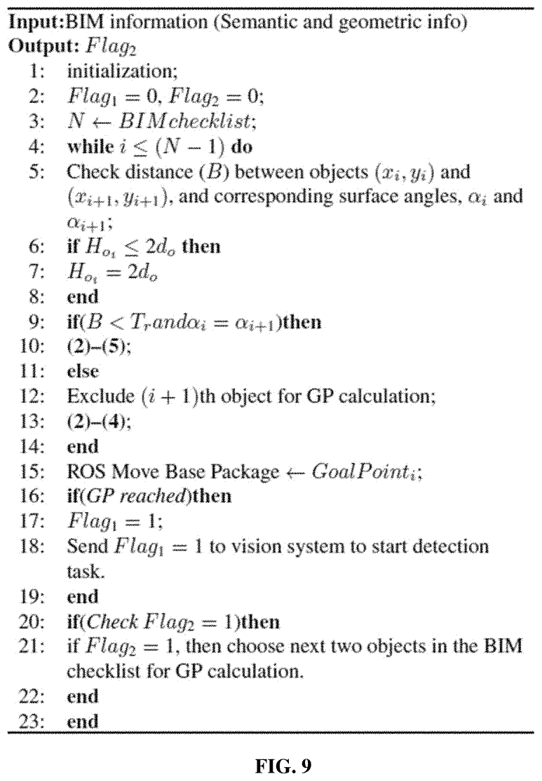

Assuming an indoor ground mobile robot application, only 2D BIM frame is considered for navigation. The coordinates of the ith GP (x_{g}_{ᵢ}, y_{g}_{ᵢ}) for the mobile robot navigation in the 2-D plane may be calculated as:

$$( \begin{matrix}{x}_{{g}_{i}} \\ {y}_{{g}_{i}}\end{matrix} ) = ( \begin{matrix}{x}_{{o}_{i}} \\ {y}_{{o}_{i}}\end{matrix} ) + ( \begin{matrix}cos {α}_{i} & - sin {α}_{i} \\ sin {α}_{i} & cos {α}_{i}\end{matrix} ) ( \begin{matrix}{d}_{i} \\ 0\end{matrix} ) \qquad Equation ( 2 )$$

where dᵢ is calculated from the geometry information, as illustrated in FIGS. 8A to 8C, and (xₒ_{ᵢ}, yₒ_{ᵢ})=(xᵢ, yᵢ) for single building object coverage. FIGS. 8A to 8F illustrate a method of determining or designing a GP for object detection based on BIM information according to various example embodiments. FIG. 8A depicts a schematic drawing of a BIM model of a working environment. FIG. 8B illustrates a GP design for two objects. FIG. 8C illustrates a computation of front distance d based on the height of the camera d₀, object size H, FoVₕ, and FoVₕ. FIG. 8D illustrates a path planning to the GP. FIG. 8E illustrates an object coverage from an arbitrary GP (as a comparative example), and FIG. 8F illustrates an object coverage from a BIM-based GP determined according to various example embodiments of the present invention.

According to various example embodiments, considering an object with total height Hᵢ, i.e., Hᵢ=zᵢ+hᵢ, where zᵢ is the z-coordinate of the target object, and hᵢ is the actual height of the object, Wᵢ is the width of the object, do is the camera height, FoVᵥ is the vertical FoV of the camera, and FoVₕ is the horizontal FoV of the camera; then, the viewing distance dᵢ may be determined according to the method as follows:

$${d}_{{v}_{i}} = \frac{( 1 + s ) ( {H}_{{o}_{i}} - {d}_{0} )}{tan ( {ϕ}_{v} )} \qquad Equation ( 3 )$$

$${d}_{{h}_{i}} = \frac{( 1 + s ) ( \frac{{W}_{{o}_{i}}}{2} )}{tan ( {ϕ}_{h} )}$$

$${d}_{i} = max ( {d}_{{v}_{i}} , {d}_{{h}_{i}} )$$

where dᵥ_{ᵢ} and dₕ_{ᵢ} are distances between the robot 504 and the object corresponding to FOVᵥ and FoVₕ, respectively, ϕᵥ=FoVₕ/2, =FoVₕ/2, s is a scaling factor set by the user to adjust the percentage of the full object in the image, and Hₒ_{ᵢ}=Hᵢ and Wₒ_{ᵢ}=Wᵢ for coverage of a single object. In various example embodiments, the condition for the minimum distance between the robot 504 and the object is dᵢ=dₘᵢₙ, when Hₒ_{ᵢ}≤2d₀. The robot's heading angle, ψᵢ, and GP coordinates may be determined as:

ψᵢ=(αᵢ−180)

GoalPoint₁=(x_{g}_{ᵢ},y_{g}_{ᵢ},ψᵢ) Equation (4)

However, if a plurality of objects (e.g., two objects) are coplanar (i.e., surface normal vectors F are the same) (e.g., satisfies a surface angle condition, such as being sufficiently coplanar) and are close to each other (e.g., satisfies a proximity condition, such as being sufficiently close to each other), according to various example embodiments, a single unified GP is generated so that the camera can cover the plurality of objects (e.g., both objects) collectively for detections, which enhances efficiency and reliability. It will be appreciated by a person skilled in the art that a proximity condition and a surface angle condition may be determined or formulated as appropriate or as desired for the intended purpose (e.g., as long they are deemed sufficiently close and sufficiently coplanar such that they are suitable to be captured collectively by a camera at one goal point), and the present invention is not limited to any specific proximity condition and any specific surface angle condition. By way of an example, if two objects, e.g., a door and a switch board, with BIM coordinates, xᵢ, yᵢ, and xᵢ₊₁, yᵢ₊₁ are sufficiently close to each other, then xₒ_{ᵢ}, yₒ_{ᵢ} in Equation (2) and Wₒ_{ᵢ} and Hₒ_{ᵢ} in Equation (3) may be determined as follows:

$${x}_{{o}_{i} ,} {y}_{{o}_{i}} = \frac{{x}_{i} + {x}_{i + 1}}{2} , \frac{{y}_{i} + {y}_{i + 1}}{2} \qquad Equation ( 5 )$$

$${H}_{{o}_{i}} = max ( {H}_{i} , {H}_{i + 1} )$$

$${W}_{{o}_{i}} = \frac{{W}_{i}}{2} + {B}_{i} + \frac{{W}_{i + 1}}{2}$$

where Hᵢ, Hᵢ₊₁, Wᵢ, and Wᵢ₊₁ are the height and width of the two consecutive objects in the BIM checklist, respectively, and Bᵢ is the distance between the two object's centers. Accordingly, as shown in FIGS. 8E and 8F, objects under inspection are fully covered when the robot 504 is placed at the BIM-based designed GP determined according to various example embodiments, as contrary to selecting an arbitrary GP using rviz utility.

Accordingly, each goal point is determined based on geometric information associated with the corresponding one or more building objects extracted from the building information model and geometric information associated with an imaging sensor of the sensor system for optimizing coverage of the corresponding one or more building objects by the imaging sensor. For example, as shown in FIGS. 8E and 8F, by determining the goal point based on such geometric information, the coverage of the corresponding one or more building objects by the imaging sensor can be advantageously optimized, resulting in automated construction progress monitoring with enhanced or improved robustness and reliability.

The GP (x_{g}_{ᵢ}, y_{g}_{ᵢ}) may then passed to a ROS package (e.g., called move base), which will attempt to reach the GP in the BIM frame using a mobile base. For example, the ROS path planner module (e.g., dynamic window approach) may be used as a local path planner and A* may be used as a global path planner.

By way of an example only and without limitation, FIG. 9 shows an example method (e.g., Algorithm 1) for BIM-based navigation to cover objects in view to perform detection tasks, according to various example embodiments of the present invention. According to the example method, BIM information may be received as an input and navigation tasks may then be performed to reach the GP of an object under inspection. A first flag signal (e.g., Flag′) may be generated and sent from the navigation system to the vision system (e.g., imaging sensor) to start the detection task when the robot 504 reaches the designated GP. If detection is successfully completed, this example method may then check the next two objects in the BIM checklist to generate the next navigation GP. A second flag signal (e.g., Flag₂) may be sent back from the vision system to the navigation system for the navigation to the next GP. In the example method, by way of an example only, the distance threshold Tᵣ (e.g., corresponding to the proximity condition as described hereinbefore according to various embodiments) between two objects may be selected as 1.5 m.

### Construction Component Installation and Defect Detection Based on Data and Information-Driven Cnn Detector: Vision System

### You Only Look Once (YOLO) for Detection Algorithm for Component Installation Check

YOLO is a CNN-based single-stage object detector that processes an image in a single framework by performing detection as a regression problem to predict bounding box coordinates and their associated class probabilities. It has low inference time due to its simple and efficient architecture, making it a preferred choice for faster real-time object detection applications. Among the YOLO family, YOLOv3 is the state-of-the-art detector with a 53-layer CNN feature extractor, and by way of an example only and without limitation, this deep architecture is employed as an example for the data and information-driven CNN detector according to various example embodiments of the present invention. To train the detection models, for example, more than 5000 training images were collected from an ongoing PPVC construction project site. The training images were collected over months to cover the PPVC construction sites at different stages of the project completion. These images were taken under varying lighting conditions and at different angles and distances in multiple sites to get a diverse training dataset. To ensure the desired detection performance, all images were captured in good quality and in focus. The YOLOv3 utilizes residual connections and performs detection across three different scales, like feature pyramid networks.

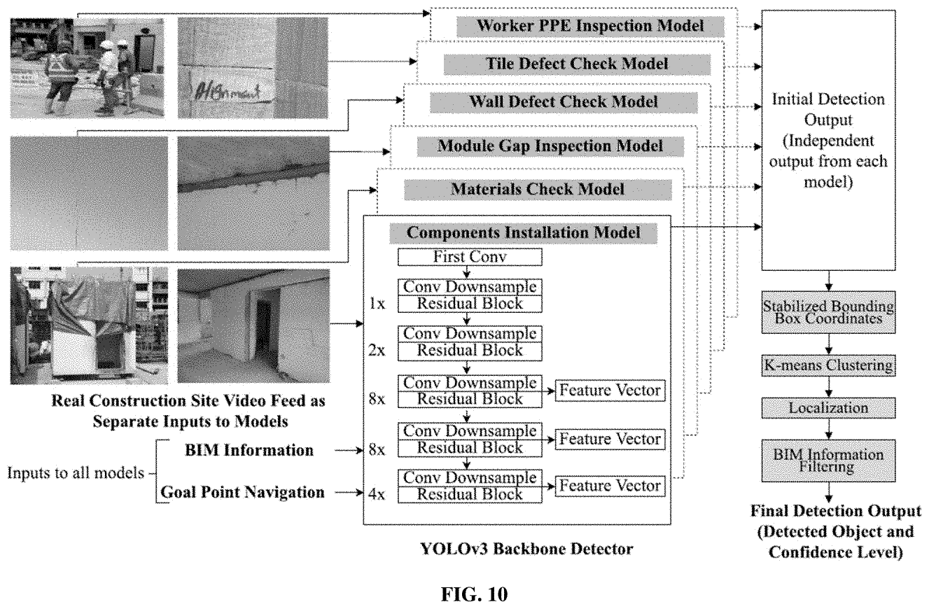

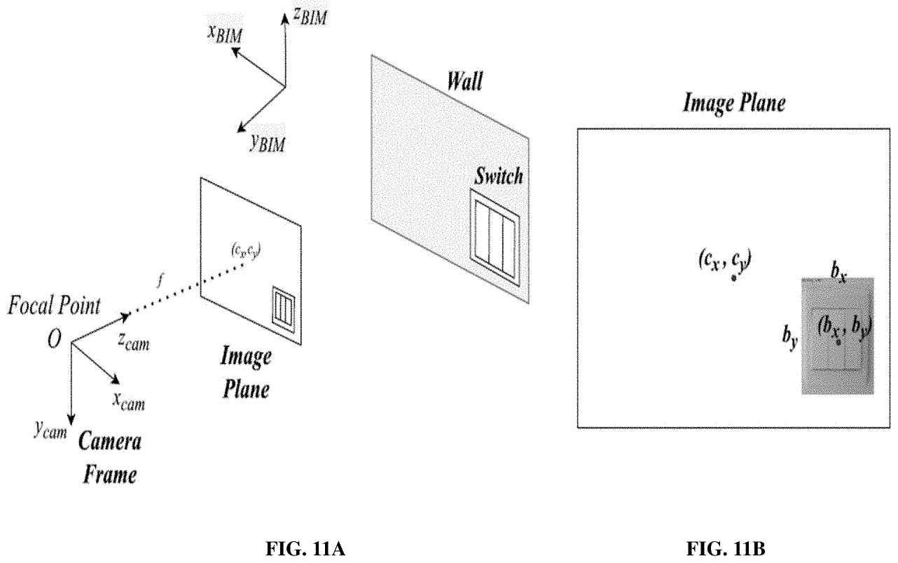

FIG. 10 depicts a schematic drawing illustrating an example data and information-based CNN detector according to various example embodiments of the present invention. As shown, an input image may be fed into the CNN feature extractor, and subsequent upsampling along with concatenation of previous layers results in a feature map of three different scales. Each scale corresponds to an (S×S) grid in the input image, where each grid cell predicts B-bounding boxes with x and y coordinates (bₓ, b_{y}), and bounding box width and height (b_{w}, bₕ) using linear regression, its objectness score O using logistic regression, and the corresponding class of the object within the bounding box using binary cross-entropy. Each grid is assigned a set of anchor boxes with dimensions (p_{w}, pₕ), and YOLO predicts the bounding box dimensions relative to the anchor boxes, which reduces the range of values of predictions. Finally, the detections of all three layers undergo nonmaximal suppression to eliminate multiple overlapping predictions. However, the YOLOv3 detector suffers from high variance in bounding box predictions, false detection, and misclassifications. To address this problem, according to various example embodiments, a moving average is applied to avoid the coordinates of the bounding boxes from changing dramatically with respect to time. On top of that, to enhance or ensure detection consistency, detections across multiple frames are processed using a K-means clustering algorithm, which outputs only the detections that are consistent across multiple frames and removes sparsely occurring false detections. To alleviate false detections and misclassifications, various example embodiments found that the visual information alone may be insufficient. To address this problem, a data and information-driven approach is provided according to various example embodiments, where metadata from the BIM and onboard sensors information are utilized to remove false detections and to ensure reliable components installation and defect detection in the PPVC construction site, as also illustrated in FIG. 10. A method of BIM-based false detection filtering will now be described according to various example embodiments of the present invention.

### BIM-Based False Detection Filtering

Some construction components share similar visual features, especially when captured from a certain angle under particular illumination conditions causing inconsistent detection. This may undesirably give rise to false detection when the K-means algorithm is not able to eliminate the consistent detection. To solve this problem, according to various example embodiments, the geometrical information from the BIM such as the object's location, orientation, and dimensions is used to filter out false detections.

In various example embodiments, object localization is performed before BIM-based filtering. First, the camera is calibrated to obtain intrinsic parameters, e.g., image center point (cₓ, c_{y}), focal length (f), both in pixels, and distortion coefficients, as illustrated in FIG. 11. In particular, FIG. 11A illustrates the camera frame and the BIM frame, and FIG. 11B illustrates the object detection in the image plane. These parameters are used to rectify the image and localize the detected object, according to various example embodiments of the present invention.

From the YOLO detection results, the centers of the objects in the image frame, bₓ and b_{y}, are known. As the robot 504 is facing the target object for inspection, in this application, the distance D to the detected object is directly taken from a frontal ray of the lidar sensor, and the 2D image points may be converted to 3D points in camera frame as follows:

$$( \begin{matrix}{x}_{c a m} \\ {y}_{c a m} \\ {z}_{c a m}\end{matrix} ) = ( \begin{matrix}( {b}_{x} - {c}_{x} ) * D / f \\ ( {b}_{y} - {c}_{y} ) * D / f \\ D\end{matrix} ) \qquad Equation ( 6 )$$

Furthermore, to obtain object location in the BIM frame, 3D camera frame points may be transformed to the BIM frame through successive homogeneous transformations, as follows:

X^{BIM}=Tₘₐₚ^{BIM}·T_{robot}^{map}·T_{lidar}^{robot}·T_{cam}^{lidar}·X^{CAM} Equation (7)

where Tₐ^{b} represents the homogeneous transformation matrix from frame a to frame b; X^{BIM}, X^{CAM}∈ [symbol] ^{4×1} are position vectors in homogeneous coordinate of the BIM frame and the camera frame, respectively.

The localized object's size, location, and orientation may then be compared with BIM information. The detected components that do not agree with the BIM ground truth (e.g., does not satisfy a matching condition, such as not sufficiently similar or within a predetermined difference threshold) are removed automatically from the detection list. It will be appreciated by a person skilled in the art that a matching condition may be determined or formulated as appropriate or as desired for the intended purpose, and the present invention is not limited to any specific matching condition.

The filtered detection output is, therefore, a bilateral verification from both the prior offline BIM information and the real-time detection output from the detector. With BIM-based filtering according to various example embodiments of the present invention, the data and information-driven detection model provides a robust and intelligent automated solution to installation and defect inspection.

### Fine Maneuver Using Sensor Information

When the robot 504 executes BIM-based navigation (e.g., as given in Algorithm 1 shown in FIG. 9), the final GP may not be reachable in some cases due to inaccuracies in the navigation system. In cases where small objects are to be observed (image capturing) from a closer viewpoint with respect to the robot 504, a new GP is determined using a fine maneuver technique according to various example embodiments. In various example embodiments, the detections obtained from the current GP may be used as visual information for the robot 504 to perform fine maneuvers to reach a better viewpoint so as to obtain detections with higher confidence. In various example embodiments, two values, namely, yaw and move distance, (Y M), are calculated or determined from the current detections and the camera's intrinsic parameters for fine-grain rotation and linear adjustment to better observe (image capturing) the object under inspection by the camera of the robot 504. The yaw angle may be calculated or determined from the difference between the image and bounding box centers (e.g., corresponding to the reference point in the image of the corresponding one or more building objects obtained and a reference point for one or more bounding boxes of the corresponding one or more building objects detected in the image, as described hereinbefore according to various embodiments) as:

$$yaw : {Δθ}_{x i} = {tan}^{- 1} ( \frac{{c}_{x} - {b}_{x i}}{f} ) \qquad Equation ( 8 )$$

where positive and negative values of yaw(Δ θₓᵢ) angle indicate rotation in the clockwise and anticlockwise direction, respectively.

In various example embodiments, the move distance is calculated by making fine adjustments to the current distance D between the robot 504 and the object. Since the detection output is relative to the anchor boxes, various example embodiments found that moving to a viewpoint in which the object dimension in the image frame resembles that of the anchor box, advantageously provides high confidence detection. The magnitude of change may be calculated from the difference between the current object height and the anchor box height of that object (e.g., corresponding to the dimension of the object and the dimension of the anchor box for detecting the corresponding one or more building objects in the image, as described hereinbefore according to various embodiments), as follows:

$$move distance : {M}_{d i} = D ( 1 - \frac{{b}_{h i}}{{p}_{h i}} ) \qquad Equation ( 9 )$$

where bₕᵢ is the object height of the ith object in the image plane obtained from the detection and pₕᵢ is the anchor box height of the ith object. The positive Ma value indicates a forward movement of the robot toward the object, while a negative value refers to backward motion.

Since the camera is fixed and the robot 504 cannot execute pitch movements, there are chances that the objects can go outside the FOV while performing the fine maneuver. To address this potential issue, according to various example embodiments, an upper limit on the move distance, M_{d}^{max}, may be formulated or provided, which ensures that objects do not go outside the FOV when moving forward, as follows:

$$Max . Move distance : {M}_{d}^{max} = D ( 1 - \frac{β}{{I}_{h} / 2} ) \qquad Equation ( 10 )$$

$$where β = max ( \vert {b}_{y i} - {c}_{y} \vert + ( {b}_{h i} / 2 ) ) ∀ i$$

For multiple objects in a single frame, the Y, M values may be determined or calculated individually for every object, and the arithmetic mean of yaw values and maximum value of move distances max(M_{di}) may then be considered as the final output. If the calculated move distance is beyond the upper limit, then the maximum move distance M_{d}^{max} may be considered as the final output. The calculated yaw and move distance values are with respect to the camera frame, and to move the mobile robot to the fine (or new) goal point, these values may be first converted into displacement in the 2D x- and y-axis as follows:

Δxᵢ=M_{di}·sin Δθₓᵢ

Δyᵢ=M_{di}·cos Δθₓᵢ Equation (11)

and then converted to robot frame, using frame transformations defined in Equation (7). The displacement in x and y directions with respect to the robot frame, Δxᵢ^{r}, Δyᵢ^{r} are converted to fine GP in the BIM frame as follows:

$$( \begin{matrix}{x}_{g i}^{F} \\ {y}_{g i}^{F}\end{matrix} ) = ( \begin{matrix}{x}_{{g}_{i}} \\ {y}_{{g}_{i}}\end{matrix} ) + ( \begin{matrix}cos {ψ}_{i} & - sin {ψ}_{i} \\ sin {ψ}_{i} & cos {ψ}_{i}\end{matrix} ) ( \begin{matrix}Δ {x}_{i}^{r} \\ Δ {y}_{i}^{r}\end{matrix} ) \qquad Equation ( 12 )$$

where x_{gi}^{F}, y_{gi}^{F} is the fine maneuver GP in 2D, x_{g}_{ᵢ}, g_{g}_{ᵢ} is the current position, and ψᵢ is the current heading of the robot 504. The heading of the robot 504 at fine GP is ψᵢ^{F}=(α−180).

### Experimental Setup and Results

Detection results of data collected from construction site and supplementary testing done in laboratories will now be discussed to demonstrate or verify the effectiveness (robustness and reliability) of the data and information driven RAOD approach for construction automation according to various example embodiments of the present invention. The images for training YOLOv3 model were collected in an ongoing PPVC construction site for residential flats by using a handheld camera.

From the training dataset, six detection models, namely, the component installation model, material check model, PPVC module gap inspection model, wall defect check model, tile defect check model, and worker's PPE inspection model were trained separately on a 4× Tesla V100 GPU server running on Linux platform. During the training phase, the models were trained at a learning rate of 0.001, 4000 steps per class, and a momentum of 0.9 on input images of size 608×608. Data augmentation was used to improve model generalization. The training time needed to train a model was approximately 8 h. The testing images were from a separate dataset, and only the detections with a confidence level higher than a threshold of 0.8 were considered. The detection result from the trained object detector was combined with the information extracted from the BIM to realize the data and information-driven object detector, according to various example embodiments of the present invention.

The experimental results are organized into two parts. First, detection results based on testing videos and images obtained from the actual construction site by using the handheld camera are presented. Second, experimental results based on the RAOD system according to various example embodiments are presented. However, due to the activity restrictions enforced on actual construction sites during the COVID pandemic, the experiments using the mobile robot system were only performed in the laboratory environment.

### Detection Results From Construction Site Dataset

Detection models were trained and tested on this dataset to perform detection tasks, such as installation check, construction material detection, and construction defect detection on PPVC building components.

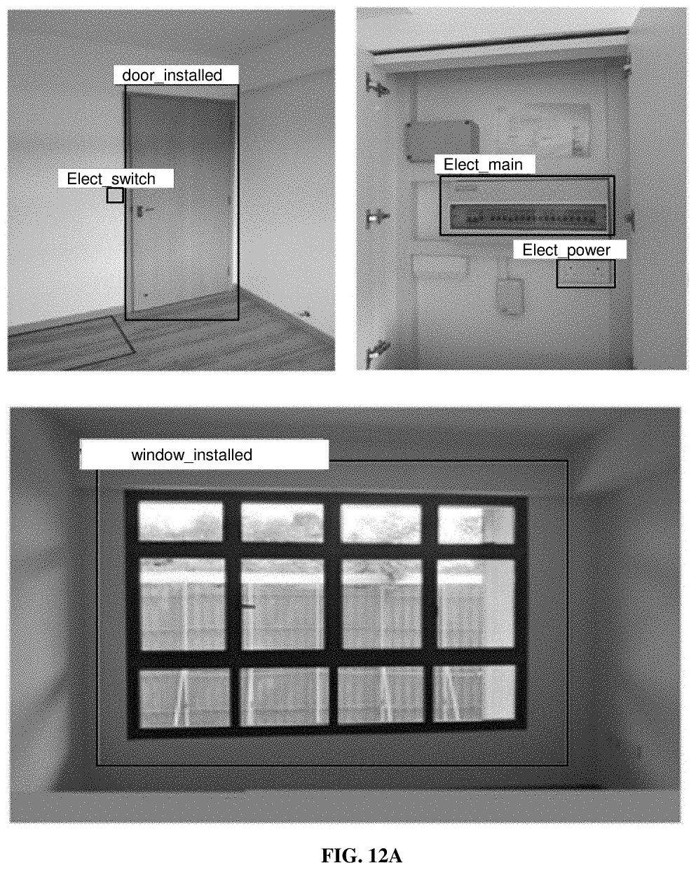

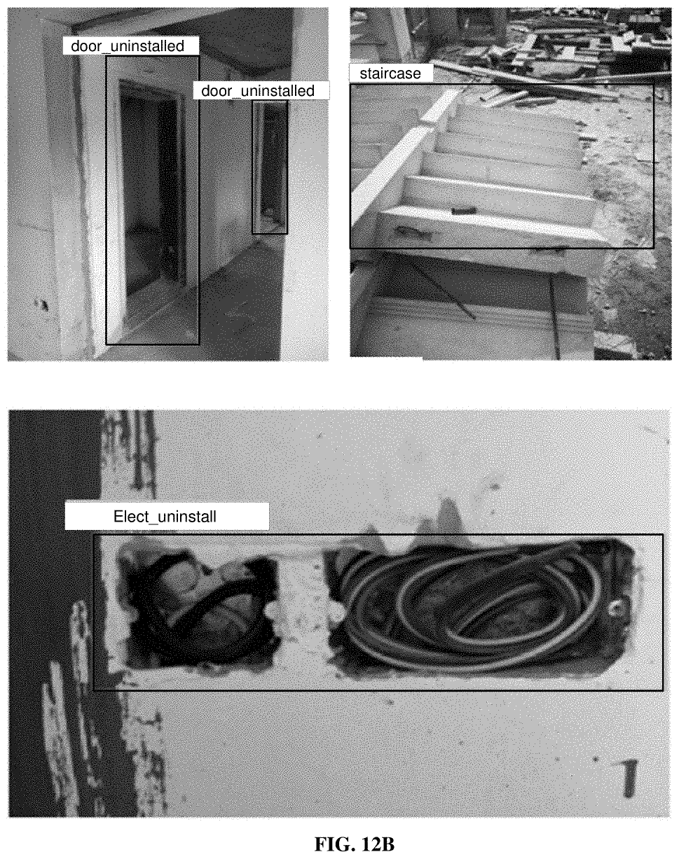

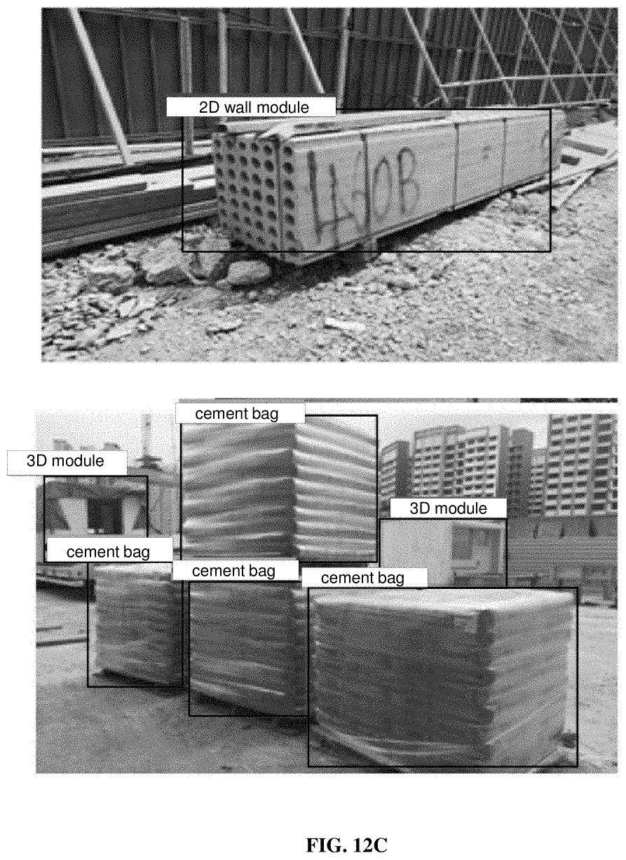

As an example, detection results from component installation monitoring will be discussed. The performance of the YOLOv3 detector model was evaluated on component installation check and material detection in terms of mean average precision (mAP). From the training data, a baseline mAP of 74.13% was achieved for the installation check model and 47.57% for the material detection model. The mAP for installation components was calculated from 220 test images with an intersection over union (IoU) threshold at 0.8 and 0.5 for construction materials with 152 images. The detection results of building components at the actual construction site are shown in FIGS. 12A to 12C. In particular, FIGS. 12A and 12B show the detection results of installed building components, and FIG. 12C shows the detection results of building material and PPVC blocks. The detection results show that the trained YOLOv3 model according to various example embodiments is able to detect building components and materials and report their status accordingly.

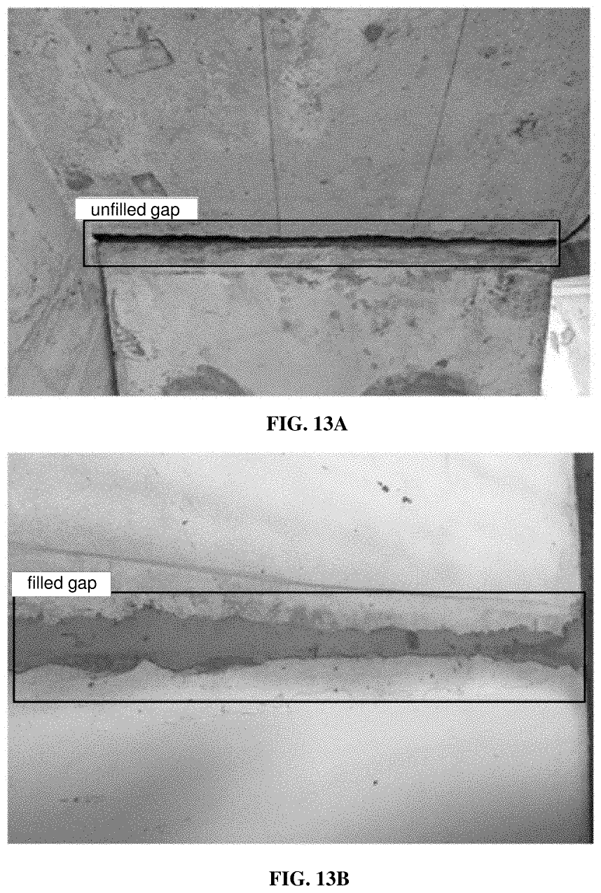

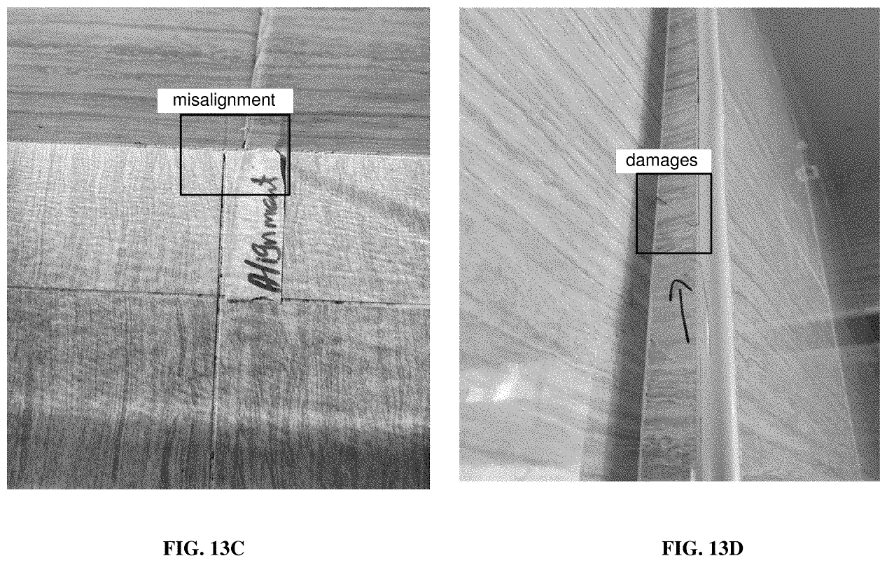

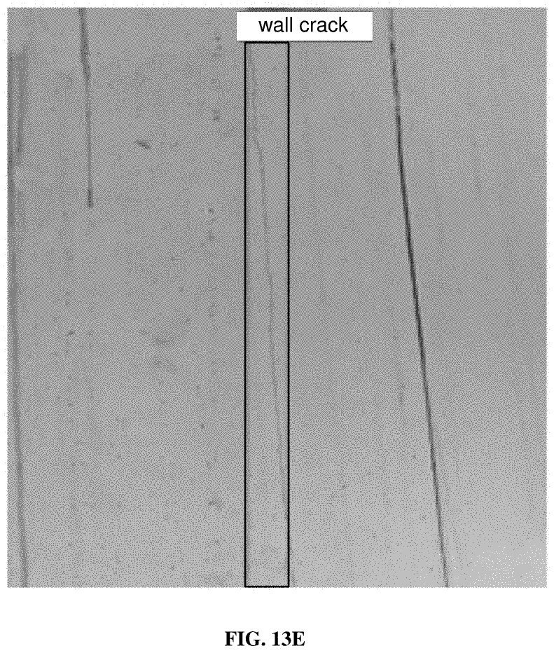

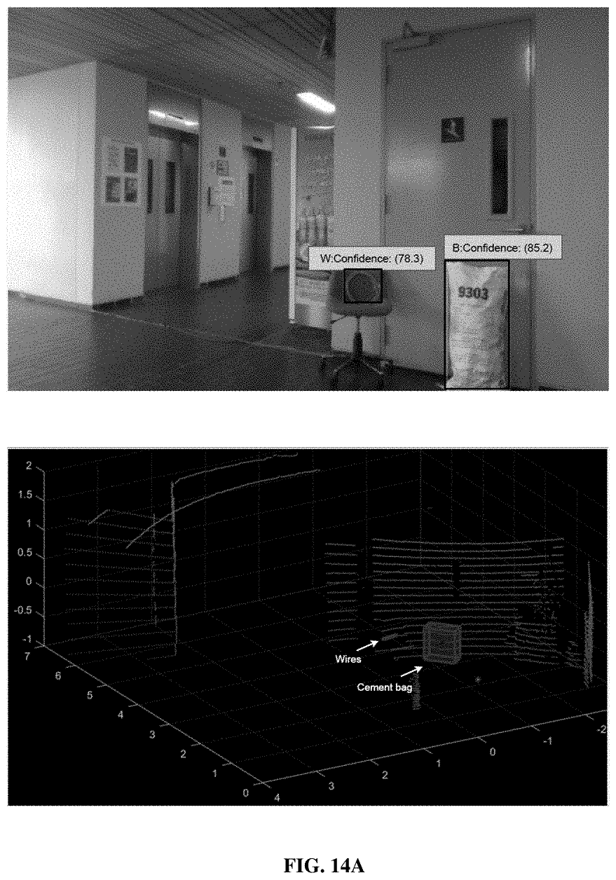

As another example, installation gap inspection and defect check will be discussed. The detection results for various defects in the construction process are presented. The detection models for PPVC module gap inspection, wall crack check, and tile defect check were independent and trained separately. During the test time, the individually trained models were grouped together to form a defect check module capable of performing multiple defect check tasks simultaneously. FIGS. 13A and 13B show the module gap detection results, while tiles defects, tiles misalignment, and wall cracks are presented in FIGS. 13C to 13E, respectively. In particular, FIG. 13A illustrates detection results for an unfilled gap between staircase module and corridor, FIG. 13B illustrates detection results for a filled gap between two PPVC blocks, FIG. 13C illustrates detection results for a misalignment between tiles, FIG. 13D illustrates detection results for tile damages, and FIG. 13E illustrates detection results for wall crack detection by the RAOD in a real PPVC dataset.

### RAOD Detection Results in Laboratory Environment

RAOD detection results performed in a laboratory environment using the mobile robot system, as shown in FIGS. 5 and 8A to 8C, will now be presented. The YOLOv3 model trained on real site images was tested on laboratory data. The localization of different building components and defects was performed.

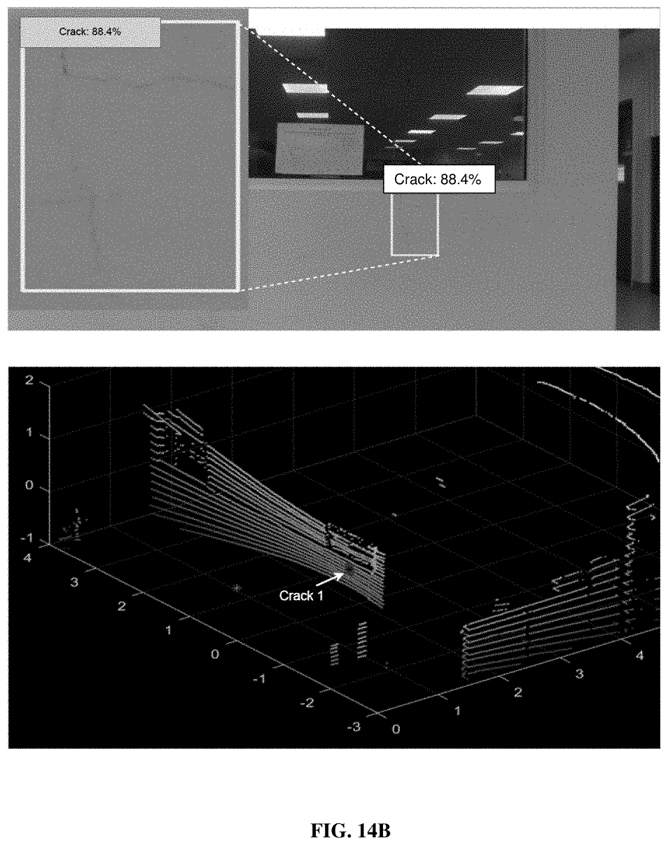

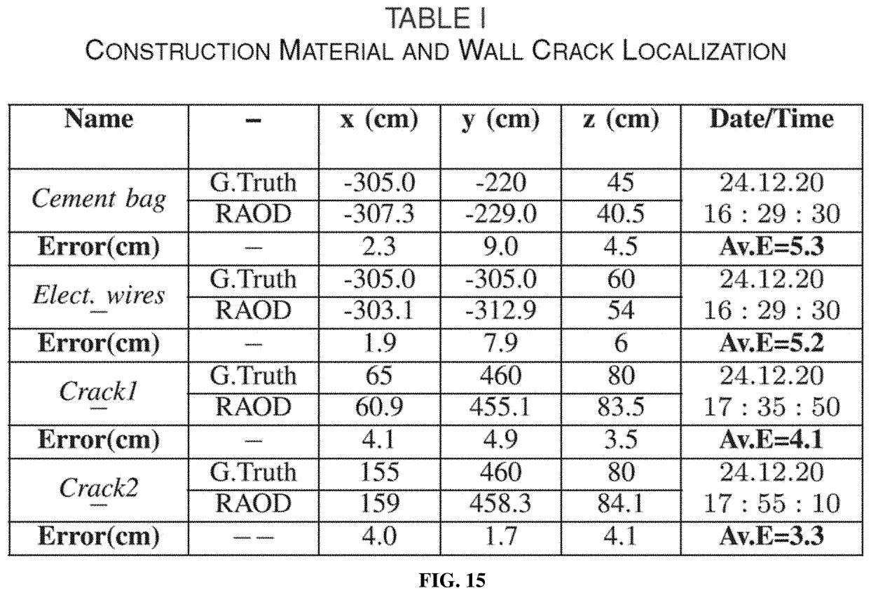

As an example, localization of building materials and wall cracks will now be further described according to various example embodiments of the present invention. As the BIM model has no construction materials and defects information, their location cannot be compared with BIM data, and pre-calculated GPs cannot be designed to detect building material. To address this, according to various example embodiments, a sensor fusion approach is utilized to localize building materials and wall defects. To obtain 3D location information in the BIM frame, the detection bounding boxes of building material in the camera frame are transformed in the BIM frame with the help of camera intrinsic parameters and a transformation matrix between camera and lidar sensors, as given in Equation (7). Note that BIM frame origin and ROS map origin are matched before starting the experiments. FIGS. 14A and 14B show the detection (2D detection in camera frame) and localization (3D localization in lidar frame) results of some of the common building materials onsite, e.g., cement bags and electrical wires in a laboratory environment, and wall defects (wall cracks). The localization results of these materials and wall defects are presented in Table I shown in FIG. 15. In Table I, G.Truth is ground truth obtained from tape measure. Two cracks were detected during scanning this wall in lab experiment. The average localization error is given as (Av.E) in centimeters.

Similarly, to check the wall cracks, the user selects a wall to be inspected, and the robot autonomously navigates to the targeted wall and scans it for any defects. The robot scans the wall with camera and lidar sensors and, with the help of sensor fusion, localizes wall cracks and defects in the BIM frame. During these experiments, the current date and time were also recorded to keep track of the inspection time.

The absolute positions of the materials and wall cracks were measured manually with a measuring tape as ground truth, with respect to BIM origin in the robot navigation map, as it was inexpensive, and the measurements were sufficiently accurate for experimental purpose.

The localization error results with respect to BIM coordinates for each detected wall crack are shown in Table I in FIG. 15. Note that the average localization error for material detection and wall cracks is ≤5.3 cm in this experiment, which is sufficient to locate the detected object and notify the site supervisor.

As another example, BIM-information-based false detection filtering and building component localization will now be further described according to various example embodiments of the present invention. Although achieving an mAP of 74.13% onsite images, the YOLOv3 detector may be prone to false detection. The data and information-driven approach according to various example embodiments makes use of prior meta information to perform false detection filtering by first localizing the detected bounding boxes with the mobile robot's location and transformation matrix information. Then, the ground truth of the object's location is extracted from the BIM information. The component location, dimensions, and surface normal are used to calculate the overlapping of localized values with ground truth in terms of IoU, and the components having IoU lower than a threshold are filtered out.

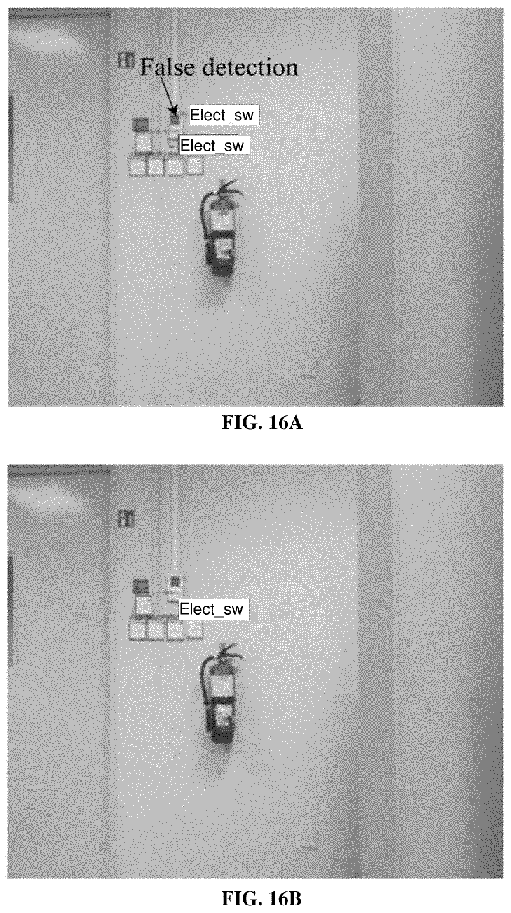

An example of how the detector according to various example embodiments filters out false detection using BIM information is shown in FIGS. 16A and 16B. In particular, FIG. 16A shows that the YOLOv3 detector detects six switches and one of them is a false detection, and FIG. 16B shows the data and information driven detector according to various example embodiments filters out the false detection by comparing with BIM information.

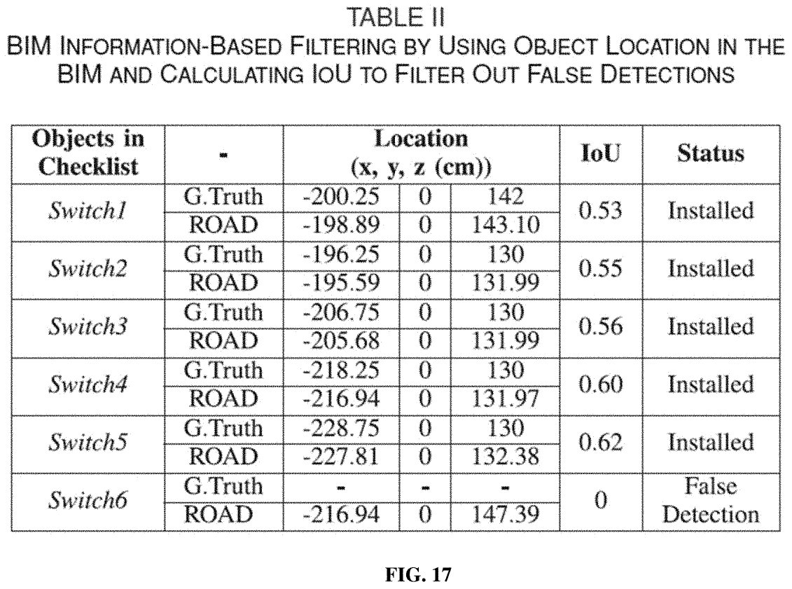

As shown in FIG. 16A, six electrical switches were detected including a false detection on a thermal controller, while FIG. 16B shows that the data and information-driven approach has accurate detection with BIM-based filtering. FIG. 17 depicts a table (Table II) showing that the falsely detected object (i.e., Switch 6) has zero IoU, while others have IoU larger than 0.5 (e.g., corresponding to a matching condition as described hereinbefore according to various embodiments). In Table II, G.Truth is ground truth location of objects in the BIM frame. Thus, false detection is advantageously filtered out with BIM-based filtering technique in the RAOD system according to various example embodiments of the present invention. The experimental results of the data and information-driven approach have also shown that the heavy dependence of an object detector on the training data can be alleviated with the utilization of BIM information. It will be appreciated by a person skilled in the art that the data and information-driven approach is not restricted to YOLOv3 but can be applied or extended to any other object detector, thereby improving its performance.

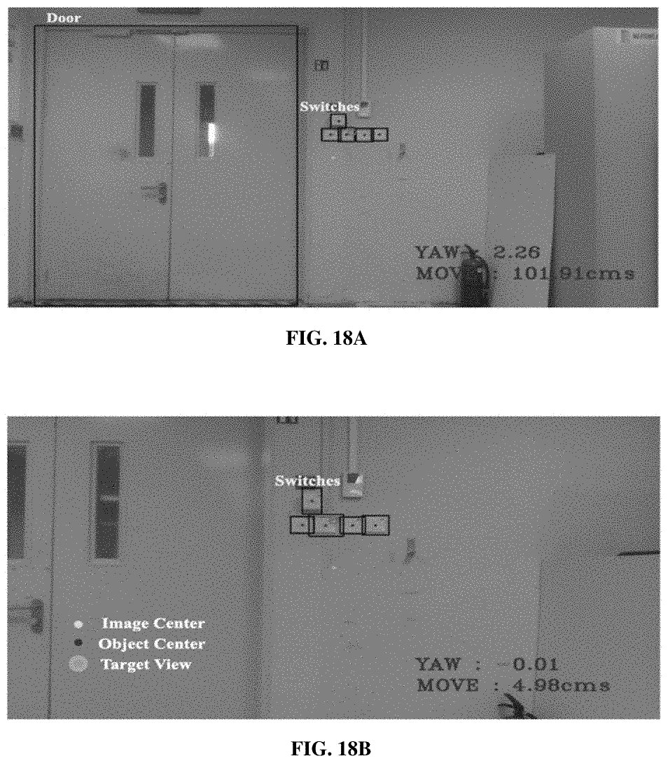

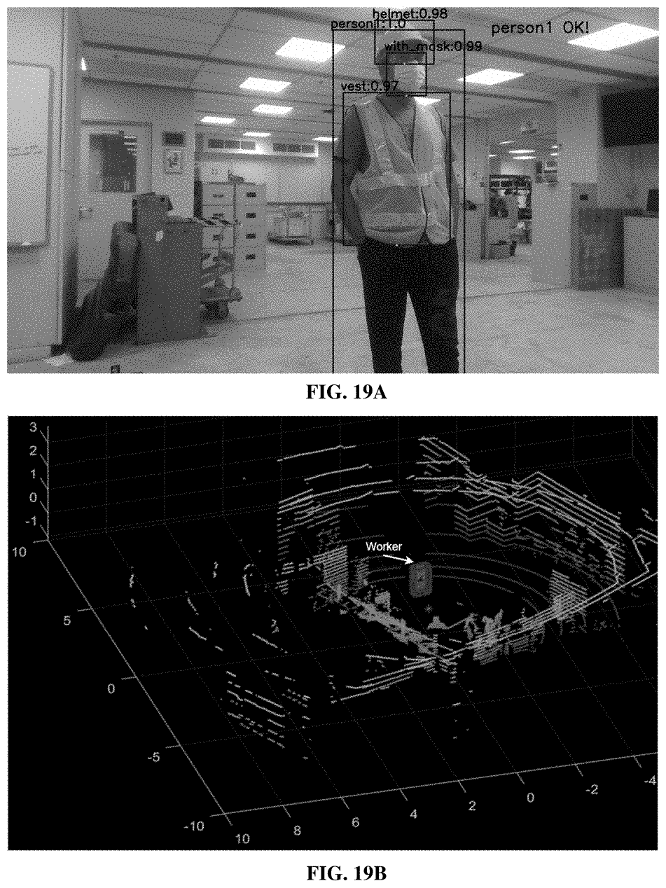

As a further example, vision-based fine maneuver of the mobile robot 504 will now be further described according to various example embodiments of the present invention. The experimental results of the mobile robot's fine maneuver are shown in FIGS. 18A and 18B. In particular, FIG. 18A shows an initial GP generated for detecting both door and switches, and FIG. 18B shows fine maneuver performed for a closer view of switches. From the BIM checklist, an initial GP is generated to check the door and the switches at the same time. However, since the switches are small objects, they are not clearly visible from the current position.

To improve detection performance, according to various example embodiments, a fine maneuver was performed to achieve a better and closer view of the switches. From the initial viewpoint, a yaw value of 2.26° and a move distance of 102 cm were calculated for the switches. The threshold values for the yaw and move distance were set to be 2° and 5 cm, respectively, to ensure high-precision maneuvers. The calculated values were in the camera frame, and these values were converted into the GP in the BIM frame and passed on to the mobile robot's navigation system to perform the fine maneuver. The mobile robot 504 takes these values as input and executes the fine maneuver by moving to the new target GP determined, thus achieving the desired viewpoint. As can be seen from FIG. 18B, the switches are perfectly centered in the image with a clear and closer view, while the yaw and move distance values are within the threshold after the fine maneuver is executed.

As another example, a safety inspection module will now be described according to various example embodiments of the present invention: The safety inspection module is configured to detect multiple safety equipment of workers, such as face masks, safety helmets, boots, and vests, as shown in FIGS. 19A and 19B. In particular, with respect to PPE safety monitoring, FIG. 19A shows the detection of PPE and inference by the safety inspection module, and FIG. 19B shows the localization of workers. For example, from the bounding box centers of the different PPE and their relative positions with the person's bounding box center, it is determined whether a worker is wearing full PPE.

### Comparison of RAOD Detector and YOLOv3

An experiment was performed to compare the performance of the RAOD system according to various example embodiments of the present invention and the performance of the conventional YOLOv3. BIM-based designed GPs were used to obtain enhanced detections to initiate the detection task.

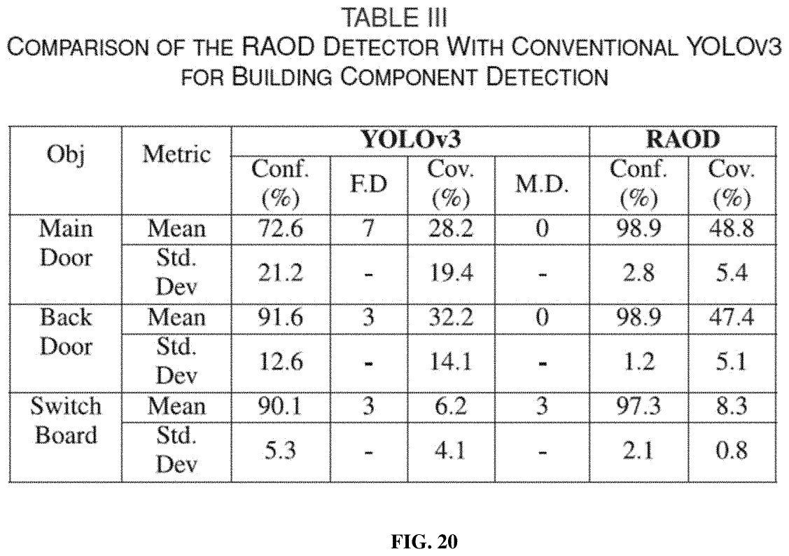

In the experiment, ten different users were asked to command the robot randomly at human judged GPs, to inspect three building components: main door, back door, and switchboard. For each experiment, detection confidence, percentage of object coverage, and data standard deviation were recorded, and results were summarized in Table III in FIG. 20. In Table III, F.D and M.D are number of false detections and misdetections, respectively. The object coverage was calculated as

$${\sum }_{i = 1}^{n} \frac{{A}_{D}^{i}}{{A}_{T}} ,$$

where A_{D} and A_{T} are detected area and the total area of the image, respectively, and n is the number of detected objects. The average detection confidence and object coverage was high with low variance in the RAOD detector. With BIM-based filtering, there was no observed false detection in the RAOD detector surpassing the conventional YOLOv3 detector performance, in which seven false detections were observed in the main door, three in the back door, and three in detecting switches. On top of that, misdetections also occurred three times in the YOLOv3 detector when detecting small objects like switches, but the RAOD detector showed no misdetection in all the experiments. The RAOD detector, therefore, outperforms the conventional approach in terms of detection confidence, object coverage, the number of false detections, and the number of misdetections.

Accordingly, various example embodiments are related to Automation-in-Construction in general and, more particularly to a system and a method of using an autonomous mobile robot for construction work process monitoring and automated report generation. The system advantageously utilizes the information embedded in BIM for robot navigation, object coverage and uses deep learning techniques for detection of construction material and architectural components for work progress monitoring.

Accordingly, a RAOD system is provided according to various example embodiments of the present invention. The RAOD system integrates the mobile robotic platform, BIM information, and image data-driven YOLOv3 detector to perform the object detection tasks in a PPVC construction site in pursuit of construction automation. BIM-based map generation is introduced for robot navigation to the specific GPs designed for optimal or maximum object coverage using BIM information and sensor data. Experimental results demonstrate that incorporating online and offline data with information from BIM alleviates problems inherent to conventional detectors, such as false detection filtering, which are minimized by leveraging BIM information. Furthermore, object coverage is maximized, and misdetections are minimized with the use of the fine maneuver technique, thus reinforcing the efficacy of utilizing the data and information-driven approach in the object detector (RAOD). The RAOD system is, thereby, capable of performing various functions in construction automation, for instance, component installation detection, building material check and localization, module gap inspection, building component defect check, and worker's safety PPE detection. For example, the RAOD system advantageously realises an automated system that can be deployed onsite to help in daily construction inspection tasks in PPVC sites. The RAOD system employed in construction work progress monitoring advantageously reduces human labour, time of inspection and hazards associated with under-construction buildings.

In various example embodiments, the ROAD system may be further extended to multifloor navigation in a PPVC construction site by installing a communication system between the elevators and the robot, enabling the wheeled robot to navigate between different levels within the same building. To move between indoor and outdoor environments, the robot may switch from GPS sensing to the BIM-based indoor navigation system. On the other hand, in a non-PPVC site where elevators are not yet ready, for example, a legged robot or drone may be used for the inspection tasks.

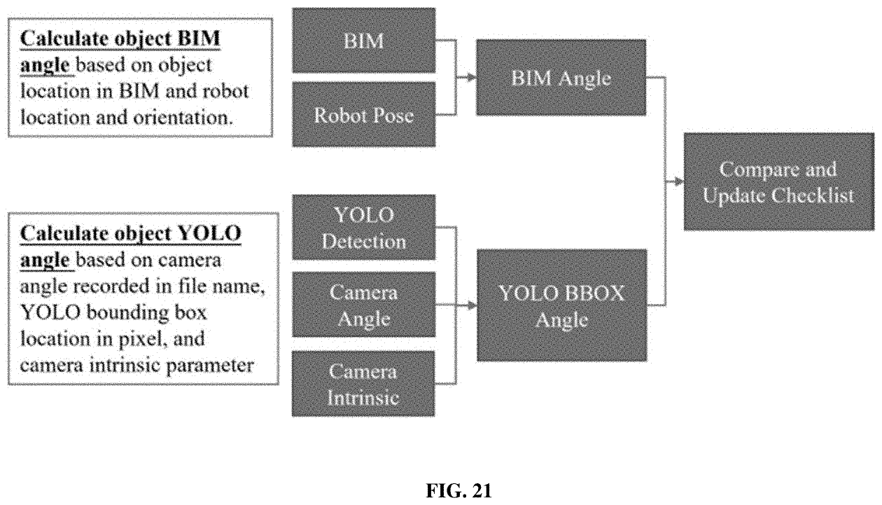

In various example embodiments, an inspection checklist update may be performed in the construction progress monitoring. FIG. 21 depicts a flow diagram illustrating the inspection checklist update process, according to various example embodiments. For example, the checklist update process may summarize the information obtained from the BIM, vision system and robot system to determine the state of building objects such as the presence of installation components. Considering the room sizes vary in different construction site, various example embodiments provide two different methods for updating the inspection checklist. For large space such as warehouses, the robot 504 may be configured to determine the goal point locations based on the component locations in the BIM and navigate to each goal point in sequence. At each goal point, a photo may be captured and named accordingly, such as based on the goal point number. The checklist update process may then compare the YOLO detection results and component classes at each goal point to update the component's state or status. For smaller spaces such as apartment rooms, the robot 504 may be configured to stop at a goal point to capture 12 images with 30-degree interval. Thus, a 360-degree full view of the room may be formed. At each goal point, the BIM angle may be calculated for all components inside the room based on the robot locations, robot orientations and component locations. Meanwhile, detection angles may also be computed using photo-capturing angle and YOLO detection bounding box locations. The checklist update process may then compare the difference between BIM angle and detection angle of each object for the same object classes. If the difference is within the threshold, the state or status of the components is updated in checklist. Accordingly, the checklist update process may be performed under different circumstances with high accuracy.

According to various example embodiments, there is provided a Digital Supervisor (DigiSup) system comprising: (a) a mobile robot equipped with navigation and perception sensors (e.g., 3D lidar, odometry, ultrasonic sensors, IMU, RGBD camera, PTZ camera, and/or a 360 degree rotating camera); (b) a BIM to retrieve information about building components and the working environment (the BIM is also used to generate navigation map); (c) data and information-driven intelligent object detector (e.g., YOLOv3 detector) to perform the object detection tasks in construction monitoring (e.g., architectural components installation detection, building materials check and localization, module gap inspection, building component defects check, and worker's safety PPE detection).

In various example embodiments, there is provided BIM-based map generation for robot navigation to the specific goal points designed from BIM information.

In various example embodiments, the BIM-based goal points are designed or determined for maximum or optimal object coverage using BIM information and sensor data.

In various example embodiments, an inspection checklist update is performed, such as described above with reference to FIG. 21.

Accordingly, the RAOD system has great utility in the domain of Automation-in-Construction. For example, automatic work progress monitoring with mobile robots will reduce dependability on skilled labor in construction area, thus assisting supervisors with quality control and quality assurance. Furthermore, adoption of the RAOD system can enhance the reliability, efficiency, and safety factors in construction industry. For example, the RAOD system may be used in residential as well commercial buildings inspection, and with the addition of more platforms, e.g., drones and legged robot, it can be extended to multiple-floor buildings and outdoor infrastructure monitoring, such as highways, bridges, tunnels and so on.

While embodiments of the invention have been particularly shown and described with reference to specific embodiments, it should be understood by those skilled in the art that various changes in form and detail may be made therein without departing from the scope of the invention as defined by the appended claims. The scope of the invention is thus indicated by the appended claims and all changes which come within the meaning and range of equivalency of the claims are therefore intended to be embraced.

1. A method of inspecting a building construction site using a mobile robotic system, the mobile robotic system comprising a mobile platform and a sensor system mounted on the mobile platform and configured to generate one or more types of sensor data, the method comprising:
receiving object identification information identifying at least one building object to be inspected by the mobile robotic system in the building construction site;
obtaining a robot navigation map covering the at least one building object based on a building information model for the building construction site; and
determining at least one goal point in the robot navigation map for the at least one building object, each goal point being a position in the robot navigation map for the mobile robotic system to navigate autonomously to for inspecting corresponding one or more building objects of the at least one building object, wherein
said each goal point is determined based on geometric information associated with the corresponding one or more building objects extracted from the building information model and geometric information associated with an imaging sensor of the sensor system for optimizing coverage of the corresponding one or more building objects by the imaging sensor.

2. The method according to claim 1, wherein
the geometric information associated with the corresponding one or more building objects comprises, for each of the corresponding one or more building objects, a location, a dimension and a surface normal vector of the building object, and
the geometric information associated with the imaging sensor comprises a height and a field of view of the imaging sensor.

3. The method according to claim 1, wherein
the at least one building object comprises a plurality of building objects, and
said determining the at least one goal point for the at least one building object comprises:
determining whether the plurality of building objects satisfy a proximity condition and a surface angle condition; and
determining one goal point for the plurality of building objects collectively if the plurality of building objects are determined to satisfy the proximity condition and the surface angle condition.

4. The method according to claim 1, wherein for said each goal point determined:
the mobile robotic system is configured to navigate to the goal point for obtaining an image of the corresponding one or more building objects; and
the method further comprises determining a state of each of the corresponding one or more building objects using a convolutional neural network (CNN)-based object detector based on the image of the corresponding one or more building objects obtained and the building information model, the CNN-based object detector comprising one or more detection models, each detection model being trained to detect a corresponding type of state of building objects.

5. The method according to claim 4, wherein the type of state of building objects is one of a building component installation completion type, a building component defect type and a building material presence type.

6. The method according to claim 4, wherein said determining the state of each of the corresponding one or more building objects comprises, for each corresponding building object:
detecting the corresponding building object in the image based on the CNN-based object detector to obtain a detection result;
localizing the detected corresponding building object in the image in a coordinate frame of the building information model;
determining geometric information of the detected corresponding building object;
determining whether the geometric information of the detected corresponding building object determined and corresponding geometric information associated with the detected corresponding building object extracted from the building information model satisfy a matching condition; and
filtering the detection result of the corresponding building object based on whether the geometric information of the detected corresponding building object determined and the corresponding geometric information associated with the detected corresponding building object extracted from the building information model satisfy the matching condition.

7. The method according to claim 6, wherein
the geometric information of the detected corresponding building object determined comprises at least one of a location, a dimension and an orientation of detected corresponding building object, and
the geometric information associated with the detected corresponding building object extracted from the building information model comprises at least one of a location, a dimension and an orientation of detected corresponding building object.

8. The method according to claim 6, wherein said localizing the detected corresponding building object in the image in the coordinate frame of the building information model comprises:
converting two-dimensional (2D) image points of the image in a coordinate frame of the image to three-dimensional (3D) image points in a coordinate frame of the imaging sensor; and
transforming the 3D image points in the coordinate frame of the imaging sensor into 3D image points in the coordinate frame of the building information model.

9. The method according to claim 8, wherein
the 2D image points of the image in the coordinate frame of the image are converted to the 3D image points in the coordinate frame of the imaging sensor based on a distance between the detected corresponding building object and the imaging sensor obtained from a distance sensor of the sensor system, and
the 3D image points in the coordinate frame of the imaging sensor are transformed into 3D image points in the coordinate frame of the building information model based on a series of homogeneous transformation matrices.

10. The method according to claim 4, further comprising, for each of one or more of said at least one goal point determined: rotating the imaging sensor based on a reference point in the image of the corresponding one or more building objects obtained and a reference point for one or more bounding boxes of the corresponding one or more building objects detected in the image.

11. The method according to claim 10, wherein the imaging sensor is rotated by an amount based on a distance between the reference point in the image and the reference point for the one or more bounding boxes.

12. The method according to claim 10, wherein
the reference point in the image is a center point thereof, and
the reference point of the one or more bounding boxes is determined based on a center point of each of the one or more bounding boxes.

13. The method according to claim 10, further comprising:
refining the goal point determined by adjusting a distance between the mobile robotic system and the building object based on a dimension of the object and a dimension of an anchor box for detecting the corresponding one or more building objects in the image.

14. The method according to claim 13, wherein the distance is adjusted based on a difference between the dimension of the object and the dimension of the anchor box.

15. The method according to claim 14, wherein
the dimension of the object is a height thereof, and
the dimension of the anchor box for detecting the object is a height thereof.

16. The method according to claim 4, further comprising generating an inspection report comprising the determined state of each of the at least one building object.

17. The method according to claim 1, wherein the building construction site is a prefabricated prefinished volumetric construction (PPVC) site.

18. The method according to claim 1, wherein the mobile robotic system comprises at least one memory and at least one processor communicatively coupled to the at least one memory, the at least one processor being configured to control the mobile platform to navigate autonomously in the building construction site based on a robot operating system (ROS).

19. A system for inspecting a building construction site using a mobile robotic system, the mobile robotic system comprising a mobile platform and a sensor system mounted on the mobile platform and configured to generate one or more types of sensor data, the system comprising:
at least one memory; and
at least one processor communicatively coupled to the at least one memory and configured to perform the method of inspecting the building construction site according to claim 1.

20. A computer program product, embodied in one or more non-transitory computer-readable storage mediums, comprising instructions executable by at least one processor to perform the method of inspecting the building construction site according to claim 1.
